(19) United States
(12) Patent Application Publication
(10) Pub. No.: US 2026/0192691 A1
(43) Pub. Date: Jul. 9, 2026

(54) IN-VEHICLE CHARGING DEVICE AND IN-VEHICLE CHARGING METHOD

(71) Applicants: AISIN CORPORATION, Kariya, Aichi (JP); NAGOYA INSTITUTE OF TECHNOLOGY, Nagoya-shi, Aichi-ken (JP)

(72) Inventors: Subrata SAHA, Nagoya-shi, Aichi-ken (JP); Mitsuru TAKAHASHI, Nagoya-shi, Aichi-ken (JP); Tomoya HIRANO, Nagoya-shi, Aichi-ken (JP); Shin TAGUCHI, Nagoya-shi, Aichi-ken (JP); Hiroaki MATSUMORI, Nagoya-shi, Aichi-ken (JP); Takashi KOSAKA, Nagoya-shi, Aichi-ken (JP)

(73) Assignees: AISIN CORPORATION, Kariya, Aichi (JP); NAGOYA INSTITUTE OF TECHNOLOGY, Nagoya-shi, Aichi-ken (JP)

(21) Appl. No.: 19/132,490

(22) PCT Filed: Feb. 14, 2024
(86) PCT No.: PCT/JP2024/004926

§ 371 Date: May 23, 2025

(30) Foreign Application Priority Data
Feb. 14, 2023 (JP) 2023-021161
Feb. 14, 2023 (JP) 2023-021162

(51) Int. Cl. B60L 53/24; H02M 1/14; H02M 3/158; H02M 7/797

(52) U.S. Cl. CPC B60L 53/24; H02M 1/14; H02M 3/158; H02M 7/797; B60L 2210/10; B60L 2210/30; B60L 2210/42

(57) ABSTRACT

An in-vehicle charging device (10) includes: an AC-DC converter (1) configured to convert AC power from an external AC power supply (4) into DC power; and a DC-DC converter (2) configured with an inverter (5) and coils (7) of a plurality of phases, one of a DC-side terminal (T5d) of the inverter (5) and a neutral point (7N) of the coils (7) of the plurality of phases being a first terminal (T21) of the DC-DC converter (2) and the other one of the DC-side terminal (T5d) and the neutral point (7N) being a second terminal (T22) of the DC-DC converter (2). An AC-side terminal (T1a) of the AC-DC converter (1) is connected to the external AC power supply (4), a DC-side terminal (T1d) of the AC-DC converter (1) is connected to the first terminal (T21), and the second terminal (T22) is connected to a DC power supply (3).

### CROSS REFERENCE TO RELATED APPLICATIONS

This application is a National Stage of International Application No. PCT/JP2024/004926 filed Feb. 14, 2024, claiming priority based on Japanese Patent Application No. 2023-021161 filed Feb. 14, 2023 and Japanese Application No. 2023-021162 filed Feb. 14, 2023.

### TECHNICAL FIELD

The present disclosure relates to an in-vehicle charging device and an in-vehicle charging method.

### BACKGROUND ART

JP 2015-201382 A discloses constant-current constant-voltage charging control as a charging control method used when a DC power supply (secondary battery) is charged with power supplied from an external power supply. Specifically, when a state of charge (SOC) of the DC power supply is low, the DC power supply is charged by constant current charging control for supplying a constant current to the DC power supply. As the charging under the constant current charging control progresses, the value of the SOC increases, and a terminal voltage (battery voltage) of the DC power supply also increases. When the SOC increases to a preset value or when the battery voltage increases to a preset value, the control method is switched from the constant current charging control to constant voltage charging control. In the constant voltage charging control, charging is continued while a voltage applied to the DC power supply is kept constant. Since the voltage applied to the DC power supply is kept constant, the charging current gradually decreases, and the charging is ended when the charging current decreases to a preset current value. In the constant-current constant-voltage charging control, the DC power supply can be charged in a relatively short time while overcharge (overvoltage) of the DC power supply is prevented.

JP 2022-503713 A (WO 2020/088945 A1) discloses an in-vehicle charging device (onboard charger) that charges a DC power supply mounted in a vehicle including a rotary electric machine as a driving power source for wheels of an electric vehicle, a hybrid vehicle, or the like in a state where the DC power supply is mounted in the vehicle (in the BACKGROUND ART, the reference signs in parentheses are those of the literature referred to). FIG. 3 of this literature illustratively shows an in-vehicle charging device in which a single-phase external AC power supply (310) is connected to a neutral point of coils of three phases connected in a Y-shape, respective arms on an AC side of an inverter (220) are connected to the respective coils of the three phases, an input-side terminal of a DC-DC converter (DC/DC converter) is connected to a DC-side terminal of the inverter (220), and the DC power supply is connected to an output-side terminal of the DC-DC converter. The coils of the three phases and the inverter (220) form an AC-DC converter (AC/DC converter) that converts a sinusoidal grid current from the external AC power supply (310) into a direct current. By performing switching control on the inverter (220), the AC-DC converter also functions as a power factor correction (PFC) circuit that corrects the power factor of DC power converted from AC power. The current after AC-DC conversion has a ripple with a frequency twice the frequency (system frequency) of the external AC power supply (310). The DC-DC converter reduces the ripple to generate a battery current for charging the DC power supply.

### CITATIONS LIST

### Patent Literature

Patent Literature 1: JP 2015-201382 A
Patent Literature 2: JP 2022-503713 A

### SUMMARY OF THE DISCLOSURE

### Technical Problems

As described above, for example, there is a case in which a vehicle including a rotary electric machine as a driving power source for wheels of an electric vehicle, a hybrid vehicle, or the like includes an in-vehicle charging device (onboard charger) that charges a DC power supply in a state where the DC power supply is mounted in the vehicle. Moreover, in this case, a part of a circuit forming the in-vehicle charging device may be configured using a drive system circuit for the rotary electric machine, including coils (stator coils) of the rotary electric machine. In many cases, an inverter that converts power between direct current and alternating current is disposed between the rotary electric machine and the DC power supply, and a smoothing capacitor that smooths a DC voltage is disposed between the inverter and the DC power supply. In a case where the inverter and the smoothing capacitor are included in the drive system circuit for the rotary electric machine, used in the in-vehicle charging device, a voltage between terminals (DC link voltage) of the smoothing capacitor is often kept at a constant voltage value in constant-current constant-voltage charging. On the other hand, a voltage between terminals (battery voltage) of the DC power supply is low at the start time of charging control at which the SOC is low, and increases with the progress of constant current charging control. Therefore, at the start of the charging control, a voltage difference between the DC link voltage and the battery voltage is large, and loss such as switching loss in the in-vehicle charging device tends to increase. That is, in the conventional constant-current constant-voltage charging control, the loss in the in-vehicle charging device tends to increase.

In addition, in the constant current charging control, the battery voltage increases with the progress of the control. Therefore, charging power based on a current flowing through the DC power supply and the battery voltage is not constant, and increases with the progress of the control. The charging power is small at the beginning of the charging control, and the charging power increases with the progress of the constant current charging control. That is, the DC power supply is not charged with the maximum allowable charging power, and thus the charging time tends to be long. Therefore, in the conventional constant-current constant-voltage system, there is room for improvement in system efficiency of the in-vehicle charging device, including charging efficiency and the loss in a switching element described above.

As described above, in the in-vehicle charging device in an electric vehicle or a hybrid vehicle, coils (stator coils) provided in a stator of a rotary electric machine as a driving power source in the vehicle can be used as coils of three phases. However, such a rotary electric machine is designed to have high power density, and has small inductance. As illustratively shown in FIG. 3 of JP 2022-503713 A (WO 2020/088945 A1), in a case where an AC-DC converter is formed by connecting a single-phase external AC power supply to a neutral point, a peak value of a harmonic current in a system current of the external AC power supply tends to increase at the time of AC-DC conversion.

As a method of reducing this, it is conceivable to increase a control frequency of an inverter forming the AC-DC converter. Alternatively, in order to reduce a ripple on a DC-DC converter side, it is conceivable to increase a control frequency of the DC-DC converter. However, when the control frequency is increased, it is necessary to shorten a control period (operation frequency) of a control device that controls the inverter or the DC-DC converter. In addition, switching at a high frequency along with a fast control period increases loss in switching elements included in the inverter and the DC-DC converter, and this leads to a decrease in efficiency of the in-vehicle charging device. Further, it is necessary to use a microcomputer or the like that can operate at a high speed as the control device, which leads to an increase in cost of the in-vehicle charging device. Alternatively, as another method, it is also conceivable to add an inductor between the external AC power supply and the neutral point of the coils of a plurality of phases. However, also in this case, the cost of the in-vehicle charging device increases due to the addition of the inductor.

In view of the above, it is desired to configure, while reducing an increase in system cost, an in-vehicle charging device that charges a DC power supply of a vehicle drive device including a rotary electric machine, an inverter, and the DC power supply, with power from an external AC power supply, using coils of the rotary electric machine and the inverter. Further, it is desired to provide a technique in which charging can be performed, with high efficiency, with power from an external AC power supply, through such an in-vehicle charging device.

### Solutions to Problems

An in-vehicle charging device in view of the above is an in-vehicle charging device configured to charge a DC power supply of a vehicle drive device with power supplied from an external AC power supply, the vehicle drive device including: a rotary electric machine including coils of a plurality of phases connected to each other at a neutral point, the rotary electric machine serving as a driving power source for a wheel; an inverter configured to convert power between direct current and alternating current of a plurality of phases; and the DC power supply connected to the inverter, the in-vehicle charging device including: an AC-DC converter configured to convert AC power from the external AC power supply into DC power; and a DC-DC converter configured with the inverter and the coils of a plurality of phases, one of a DC-side terminal of the inverter and the neutral point of the coils of a plurality of phases being a first terminal of the DC-DC converter and another one of the DC-side terminal of the inverter and the neutral point of the coils of a plurality of phases being a second terminal of the DC-DC converter, in which an AC-side terminal of the AC-DC converter is connected to the external AC power supply, a DC-side terminal of the AC-DC converter is connected to the first terminal of the DC-DC converter, and the second terminal of the DC-DC converter is connected to the DC power supply.

According to this configuration, out of the AC-DC converter and the DC-DC converter forming the in-vehicle charging device, the AC-DC converter requiring appropriate inductance is configured without using a drive system circuit for the rotary electric machine (the coils of the rotary electric machine and the inverter that drives the rotary electric machine). When the coil of the rotary electric machine is used in the in-vehicle charging device, there is a case in which it is difficult to obtain required performance due to small inductance of the coil. However, according to this configuration, with the AC-DC converter that does not use the coil of the rotary electric machine and in which appropriate inductance is settable, the AC-DC converter that can perform AC-DC conversion while obtaining sufficient performance such as a power factor correction function can be configured. In addition, the DC-DC converter not requiring high inductance can be configured using the drive system circuit for the rotary electric machine, and the cost of the in-vehicle charging device can be reduced. Further, since appropriate inductance is settable in the AC-DC converter, it is unnecessary to control the AC-DC converter at a short control period (high control frequency), and it is also easy to reduce loss in a switching element forming the AC-DC converter. Therefore, the system efficiency of the in-vehicle charging device is also easily increased. In this manner, according to this configuration, it is possible to configure, while reducing an increase in system cost, an in-vehicle charging device that charges a DC power supply of a vehicle drive device including a rotary electric machine, an inverter, and the DC power supply, with power from an external AC power supply, using coils of the rotary electric machine and the inverter.

Further, an in-vehicle charging method in view of the above is an in-vehicle charging method in which a DC power supply of a vehicle drive device is charged through an in-vehicle charging device to which power is supplied from an external AC power supply, the vehicle drive device including: a rotary electric machine including coils of a plurality of phases connected at a neutral point, the rotary electric machine serving as a driving power source for a wheel; an inverter configured to convert power between direct current and alternating current of a plurality of phases; and the DC power supply connected to the inverter, where the in-vehicle charging device includes: an AC-DC converter configured to convert AC power from the external AC power supply into DC power; a DC-DC converter configured to convert a voltage of DC power converted by the AC-DC converter; a smoothing capacitor disposed between the AC-DC converter and the DC-DC converter, the smoothing capacitor being configured to smooth a voltage of DC power converted by the AC-DC converter; and a control device configured to control the AC-DC converter and the DC-DC converter, either one of the AC-DC converter and the DC-DC converter being configured using the inverter and the coils of a plurality of phases, an AC-side terminal of the AC-DC converter being connected to the external AC power supply, a DC-side terminal of the AC-DC converter being connected to a first terminal of the DC-DC converter, a second terminal of the DC-DC converter being connected to the DC power supply, the second terminal of the DC-DC converter being different from the first terminal of the DC-DC converter, the in-vehicle charging method including: by the control device, setting a terminal voltage of the DC power supply exhibited when the DC power supply is in a fully charged state, as a first voltage, and setting a voltage that is lower than the first voltage and that is preset, as a second voltage, performing, as charging control, constant power charging control such that charging power based on a current flowing through the DC power supply and a terminal voltage of the DC power supply is constant, until a terminal voltage of the DC power supply reaches the second voltage from a state lower than the second voltage, and performing, in the constant power charging control, variable DC voltage control such that a terminal voltage of the smoothing capacitor increases in accordance with an increase in a terminal voltage of the DC power supply.

According to this configuration, the constant power charging control is performed such that the charging power is constant, until the terminal voltage of the DC power supply reaches the second voltage from a state in which a state of charge (SOC) of the DC power supply is low and the terminal voltage of the DC power supply is lower than the second voltage. Therefore, the DC power supply can be charged with the maximum allowable charging power, and thus the charging time can be shortened. In addition, while the constant power charging control is being performed, the variable DC voltage control is also performed. Similarly to the terminal voltage of the DC power supply that increases from lower than the second voltage toward the second voltage as the constant power charging control is performed, the terminal voltage of the smoothing capacitor is also controlled to increase. Thus, a voltage difference between the input side and the output side of the DC-DC converter is easily kept relatively small, as compared with a case in which the terminal voltage of the smoothing capacitor is kept at a constant voltage higher than the second voltage. As a result, it is easy to reduce loss such as switching loss in the in-vehicle charging device. In this manner, according to this configuration, it is possible to provide a technique in which a DC power supply of a vehicle drive device including a rotary electric machine, an inverter, and the DC power supply can be charged, with high efficiency, through an in-vehicle charging device that performs charging with power from an external AC power supply, using coils of the rotary electric machine and the inverter.

Further features and advantages of an in-vehicle charging device and an in-vehicle charging method will become apparent from the description of exemplary and non-limiting embodiments given below with reference to the drawings.

### BRIEF DESCRIPTION OF DRAWINGS

FIG. 1 is a schematic circuit block diagram of a drive control system for a rotary electric machine.

FIG. 2 is a schematic block diagram of a system configuration of an in-vehicle charging device.

FIG. 3 is a schematic block diagram of a system configuration of the in-vehicle charging device in which the drive control system for the rotary electric machine is used for a DC-DC converter.

FIG. 4 is a circuit block diagram showing a first example of the in-vehicle charging device in which the drive control system for the rotary electric machine is used (used for the DC-DC converter).

FIG. 5 is a circuit block diagram showing a second example of the in-vehicle charging device in which the drive control system for the rotary electric machine is used (used for the DC-DC converter).

FIG. 6 is a circuit block diagram showing a third example of the in-vehicle charging device in which the drive control system for the rotary electric machine is used (used for an AC-DC converter).

FIG. 7 is a graph showing an example of charging control.

FIG. 8 is a graph showing a comparative example of charging control.

FIG. 9 is a schematic control block diagram for the AC-DC converter.

FIG. 10 is a schematic control block diagram for the DC-DC converter.

FIG. 11 is a diagram showing an example of a path of current in precharging control.

FIG. 12 is a diagram showing a comparative example of a path of current in the precharging control.

FIG. 13 is a diagram showing another comparative example of a path of current in the precharging control.

### DESCRIPTION OF EMBODIMENTS

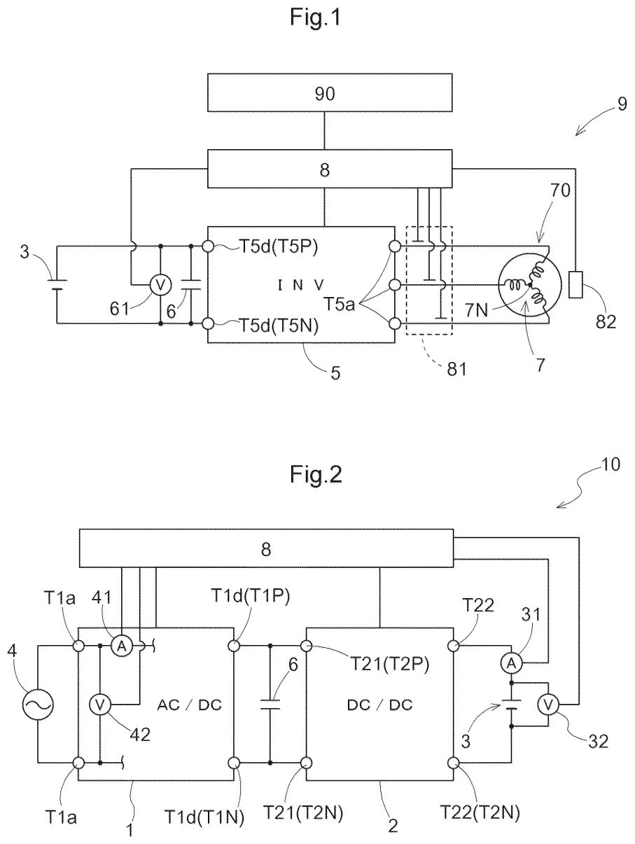

Hereinafter, an embodiment of an in-vehicle charging device will be described with reference to the drawings. An in-vehicle charging device 10 is a device that charges a DC power supply 3 included in a vehicle drive device 9 as shown in FIG. 1 in a state where the DC power supply 3 is mounted in a vehicle. FIG. 1 is a schematic circuit block diagram of a drive control system for a rotary electric machine 70 included in the vehicle drive device 9. FIG. 2 is a schematic block diagram of a system configuration of the in-vehicle charging device 10. As shown in FIG. 1, the vehicle drive device 9 of the present embodiment includes the rotary electric machine 70 serving as a driving power source for wheels of a hybrid vehicle, an electric vehicle, or the like, an inverter 5 that converts power between direct current and alternating current of a plurality of phases, and the DC power supply 3 connected to the inverter 5. Note that it is not precluded that the vehicle drive device 9 includes another driving power source such as an internal combustion engine (not shown) in addition to the rotary electric machine 70. As shown in FIG. 2, the in-vehicle charging device 10 is a device that charges the DC power supply 3 of the vehicle drive device 9 with power supplied from a single-phase external AC power supply 4 (grid power supply), and is a device called an onboard charger. In the present embodiment, the in-vehicle charging device 10 is configured by sharing parts thereof with the vehicle drive device 9. Specifically, the inverter 5, and coils 7 of the rotary electric machine 70 are shared. Preferably, as described later, a control device 8 that drives the inverter 5, and a smoothing capacitor (DC link capacitor 6) that smooths a DC voltage are also shared.

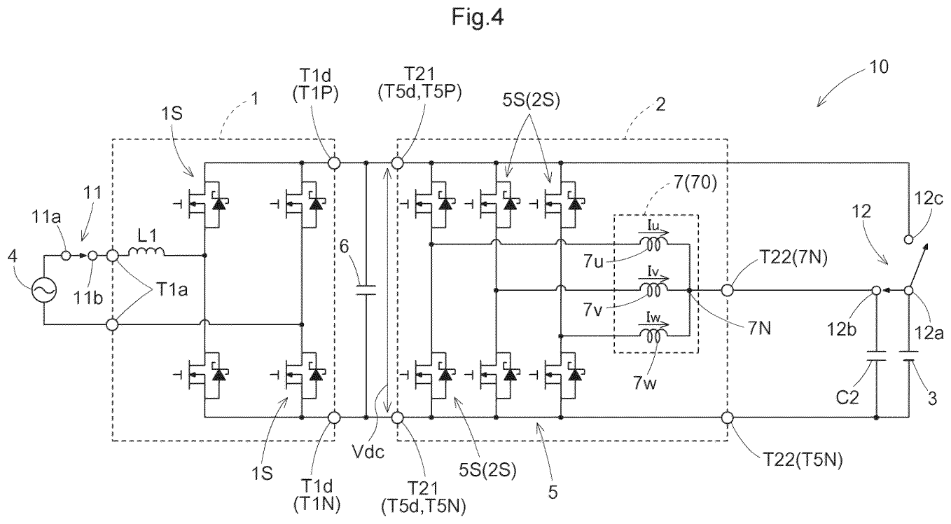

As shown in FIG. 1, the vehicle drive device 9 includes the control device 8 whose control target is the rotary electric machine 70 serving as a driving power source for the vehicle. The control device 8 performs current feedback control, thereby performing drive control of the rotary electric machine 70. The rotary electric machine 70 to be driven is an interior permanent magnet rotary electric machine (interior permanent magnet synchronous motor: IPMSM) including a stator in which the coils 7 (stator coils) of a plurality of phases (N phases where N is any natural number, a three-phase form where N=3 is exemplified in the present embodiment) are disposed in a stator core, and a rotor in which a permanent magnet is disposed in a rotor core. Such a configuration is known, and illustration of the stator core, the stator, the rotor core, the rotor, the permanent magnet, and the like is omitted in the present embodiment. The present embodiment exemplifies a Y-type form in which the coils 7 of three phases (a U-phase coil 7u, a V-phase coil 7v, and a W-phase coil 7w; see FIGS. 4, 5, 6, and the like) are short-circuited at a neutral point 7N. However, the rotary electric machine 70 may have, for example, a configuration that includes two sets of coils 7 of three phases, and that is driven by AC of six phases. Note that the rotary electric machine 70 can function as both an electric motor and a generator. When the rotary electric machine 70 functions as an electric motor, the rotary electric machine 70 is in a powering state, and when the rotary electric machine 70 functions as a generator, the rotary electric machine 70 is in a regeneration state.

As shown in FIG. 1, the vehicle drive device 9 includes the inverter 5 (see also FIGS. 4, 5, 6, and the like). The inverter 5 is connected to the AC rotary electric machine 70 and the DC power supply 3, and converts power between alternating current of a plurality of phases and direct current. A pair of DC-side terminals (DC link terminals T5d) of the inverter 5 are connected to positive and negative electrode terminals of the DC power supply 3. Specifically, a terminal on a positive-electrode side (DC link positive terminal T5P) out of the pair of DC link terminals T5d is connected to a positive electrode of the DC power supply 3, and a terminal on a negative-electrode side (DC link negative terminal T5N) out of the pair of DC link terminals T5d is connected to a negative electrode of the DC power supply 3. In addition, each of AC-side terminals (coil-side terminals T5a) of the plurality of phases of the inverter 5 is connected to a corresponding one of the coils 7 of the plurality of phases. In the present embodiment, the inverter 5 includes a U-phase arm, a V-phase arm, and a W-phase arm as arms of a plurality of phases, and each of respective middle points of the arms is connected to a corresponding one of the coil-side terminals T5a. The middle point of the U-phase arm and the U-phase coil 7u are connected, the middle point of the V-phase arm and the V-phase coil 7v are connected, and the middle point of the W-phase arm and the W-phase coil 7w are connected.

The smoothing capacitor (DC link capacitor 6) that smooths a voltage (DC link voltage Vdc) between the positive electrode and the negative electrode is provided on the DC side of the inverter 5. In addition, a voltage sensor (DC link voltage sensor 61) that detects the DC link voltage Vdc is also provided on the DC side of the inverter 5. Note that when a drive system circuit (the inverter 5, the coil 7, and the like) for the rotary electric machine 70 is used as the in-vehicle charging device 10, there is a case in which the DC link capacitor 6 is disposed between an AC-DC converter 1 and a DC-DC converter 2 to be described later with reference to FIGS. 2, 4, 6, and the like, and in which the DC link capacitor 6 also functions as a smoothing capacitor that smooths a voltage (DC link voltage Vdc) of DC power converted by the AC-DC converter 1.

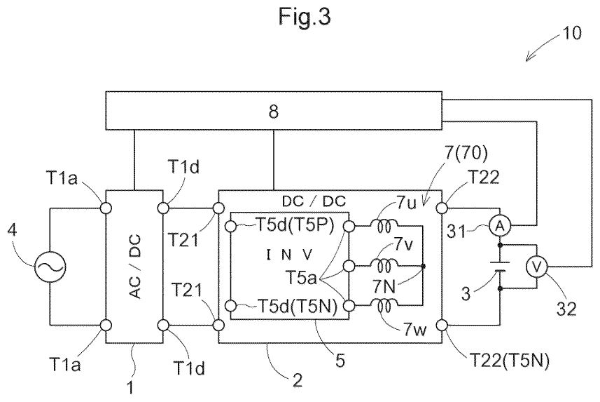

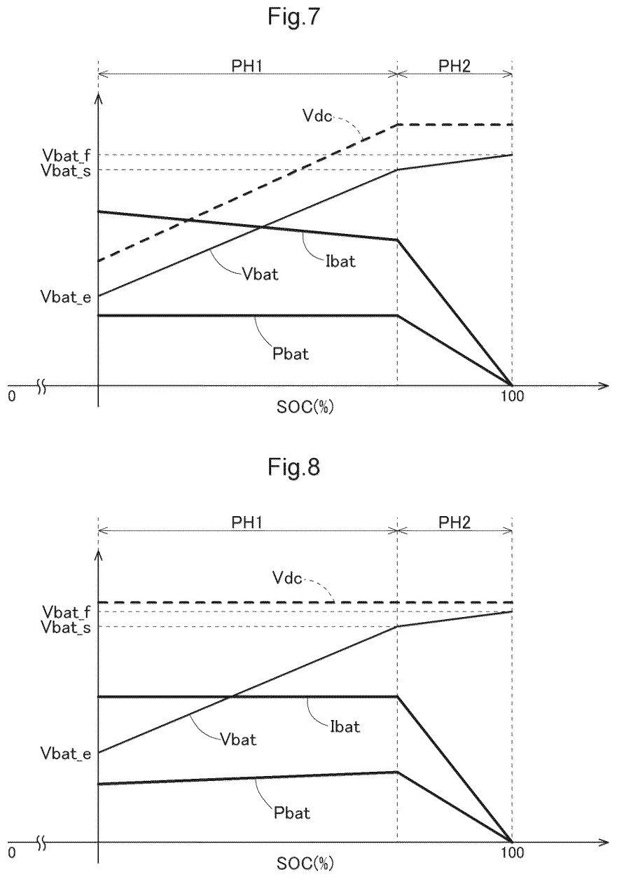

The DC power supply 3 includes, for example, a rechargeable secondary battery (battery) such as a lithium-ion battery, an electric double layer capacitor, or the like. As in the present embodiment, in a case where the rotary electric machine 70 is a driving power source for the vehicle, the DC power supply 3 is a high-voltage, high-capacity DC power supply, and the rated power supply voltage is, for example, 200 to 800 volts. In addition, the DC power supply 3 is also provided with a current sensor (battery current sensor 31) that detects input/output current (battery current Ibat; see FIG. 7 and the like) to/from the DC power supply 3, and a voltage sensor (battery voltage sensor 32) that detects a terminal voltage (battery voltage Vbat; see FIG. 7 and the like) of the DC power supply 3 (see FIGS. 2 and 3).

Although not shown, for example, in a case where the DC power supply 3 is a lithium-ion battery or the like, a battery management system (BMS) is often provided. A secondary battery such as a lithium-ion battery includes a plurality of cells (battery cells). The BMS is a battery management control system that performs: (1) prevention of overcharge and overdischarge of a cell; (2) prevention of overcurrent from flowing through a cell; (3) temperature management of a cell; (4) calculation of a state of charge (SOC); (5) equalization of a cell voltage; and the like. The battery current sensor 31 and the battery voltage sensor 32 described above may be configured as parts of the BMS.

As shown in FIG. 4 and the like, the inverter 5 includes a plurality of switching elements 5S. As the switching element 5S, it is preferable to use a power semiconductor element that can operate at a high frequency, such as an insulated gate bipolar transistor (IGBT), a power metal oxide semiconductor field effect transistor (MOSFET), a silicon carbide-metal oxide semiconductor FET (SiC-MOSFET), a SiC-static induction transistor (SiC-SIT), or a gallium nitride-MOSFET (GaN-MOSFET). The present embodiment exemplifies a configuration in which an FET is used as the switching element 5S. Note that each of the switching elements 5S includes a freewheeling diode in parallel therewith while a direction from the negative electrode toward the positive electrode (direction from a lower stage side toward an upper stage side) is set as a forward direction.

As shown in FIG. 1, the inverter 5 is controlled by the control device 8. The control device 8 is constructed using a logic circuit such as a microcomputer as a core component. For example, the control device 8 causes the rotary electric machine 70 to be driven through the inverter 5 by performing current feedback control using a vector control method, on the basis of target torque (torque command) of the rotary electric machine 70 provided as a request signal from another control device or the like such as a vehicle control device 90 or the like, which is one of higher-level control devices. In the vector control method, the feedback control is performed by causing currents (in the present embodiment, a U-phase current Iu, a V-phase current Iv, and a W-phase current 1w; see FIG. 4 and the like) flowing through the coils 7 of respective phases to be subjected to coordinate conversion into vector components of a d-axis, which is in a direction of a magnetic field generated by the permanent magnet disposed in the rotor, and a q-axis, which is in a direction orthogonal to the d-axis (a direction advanced by an electric angle of π/2 with respect to the direction of the magnetic field). A coordinate system of the converted coordinates is referred to as a d-q-axis orthogonal coordinate system. Note that an operating voltage of a logic circuit element such as the microcomputer is about 3.3 to 5 volts. In the present embodiment, although not shown for simplification, a control signal generated by the logic circuit element is transmitted to the inverter 5 via a drive circuit. Alternatively, it may be considered that the drive circuit is included in the control device 8.

Actual currents flowing through the coils 7 of the respective phases of the rotary electric machine 70 are detected by a current sensor (motor current sensor 81), and the control device 8 acquires the detection result. In addition, a magnetic pole position (electric angle) of the rotor of the rotary electric machine 70 at each time point and a rotation speed (angular velocity) of the rotor are detected by a rotation sensor 82 such as a resolver, and the control device 8 acquires the detection result. The control device 8 performs current feedback control using the detection results of the motor current sensor 81 and the rotation sensor 82. The control device 8 includes various functional parts for the current feedback control, and each functional part is implemented by cooperation of hardware, such as a microcomputer, and software (program).

As described above, the rotary electric machine 70 connected to the DC power supply 3 via the inverter 5 functions as an electric motor with power supplied from the DC power supply 3, and can also function as a generator to charge the DC power supply 3. For example, in a hybrid vehicle, it is possible to cause the rotary electric machine 70 to generate power by supplying mechanical energy to the rotary electric machine 70 using motive power of an internal combustion engine or the like. However, there is a case in which few opportunities are present for the electric power generation and the DC power supply 3 is unable to be sufficiently charged. In addition, in an electric vehicle in which only the rotary electric machine 70 is mounted as a driving power source, the electric power generation is limited to electric power generation through mechanical energy from wheels in inertial traveling or the like, and the DC power supply 3 is unable to be sufficiently charged in many cases. Further, even in the hybrid vehicle, excellent energy efficiency may be obtained by allowing electric power to be supplied from the outside as compared with a case of causing the rotary electric machine 70 to generate the electric power. Thus, the DC power supply 3 is preferably configured to be able to be charged by an external power supply in a state where the DC power supply 3 is mounted in the vehicle.

The in-vehicle charging device 10 of the present embodiment charges the DC power supply 3 of the vehicle drive device 9 with power supplied from the external AC power supply 4. In the present embodiment, a single-phase AC power supply is shown as an example of the external AC power supply 4. However, it is not precluded that the external AC power supply 4 is a multi-phase AC power supply such as a three-phase AC power supply. As shown in FIG. 2, the in-vehicle charging device 10 includes the AC-DC converter 1 (AC/DC converter) that is connected to the external AC power supply 4 and that converts AC power from the external AC power supply 4 into DC power, and the DC-DC converter 2 (DC/DC converter) that converts a DC voltage converted by the AC-DC converter 1. The AC-DC converter 1 includes a pair of AC-side terminals T1a and a pair of DC-side terminals T1d, and the AC-side terminals T1a of the AC-DC converter 1 are connected to the external AC power supply 4. The DC-DC converter 2 includes a pair of first terminals T21 and a pair of second terminals T22. The pair of first terminals T21 and the pair of DC-side terminals T1d of the AC-DC converter 1 are connected, and the pair of second terminals T22 and positive and negative electrode terminals of the DC power supply 3 are connected.

The AC-DC converter 1 and the DC-DC converter 2 include switching elements (switching elements denoted by the reference signs 1S, 2S, 5S, and 15S in FIGS. 4, 5, 6, and the like), and these switching elements are controlled by the control device 8 that performs drive control of the rotary electric machine 70 through the inverter 5. Therefore, the control device 8 also handles the AC-DC converter 1 and the DC-DC converter 2 as control targets of the control device 8. Further, as described later, the in-vehicle charging device 10 includes contactors (contactors denoted by the reference signs 11,12, and 13 in FIGS. 4, 5, and 6). These contactors are also controlled by the control device 8, or by the control device 8 and the vehicle control device 90. As described above with reference to FIG. 1, the control device 8 is included in the drive control system for the rotary electric machine 70, and the control device 8 is also shared for drive control of the rotary electric machine 70 and charging control of the DC power supply 3.

When the DC power supply 3 is charged, power is supplied from the external AC power supply 4 to the DC power supply 3. Therefore, in the circuit configuration, there is a case in which the AC-DC converter 1 disposed relatively on the external AC power supply 4 side (upstream side) is referred to as a front-end converter or a front converter, and in which the DC-DC converter 2 disposed relatively on the DC power supply 3 side (downstream side) is referred to as a back-end converter or a back converter. As shown in FIG. 2, the in-vehicle charging device 10 can be configured, by using the inverter 5 and the coils 7 of the plurality of phases in either one of the AC-DC converter 1 (front converter) and the DC-DC converter 2 (back converter). In addition, as shown in FIG. 2, the AC-DC converter 1 is provided with a grid current sensor 41 and a grid voltage sensor 42 in order to detect AC current and AC voltage.

Note that as shown in FIG. 3, in the in-vehicle charging device 10, the AC-DC converter 1, which is a front converter connected to the external AC power supply 4, may include a circuit formed separately from the vehicle drive device 9, and the DC-DC converter 2, which is a back converter connected to the DC power supply 3, may be configured by sharing the drive system circuit (the coils 7 and the inverter 5) for the rotary electric machine 70.

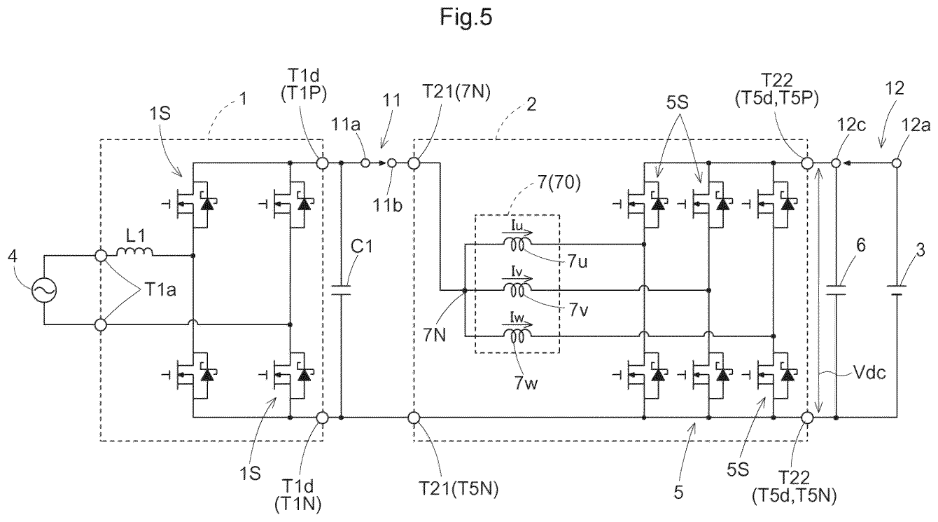

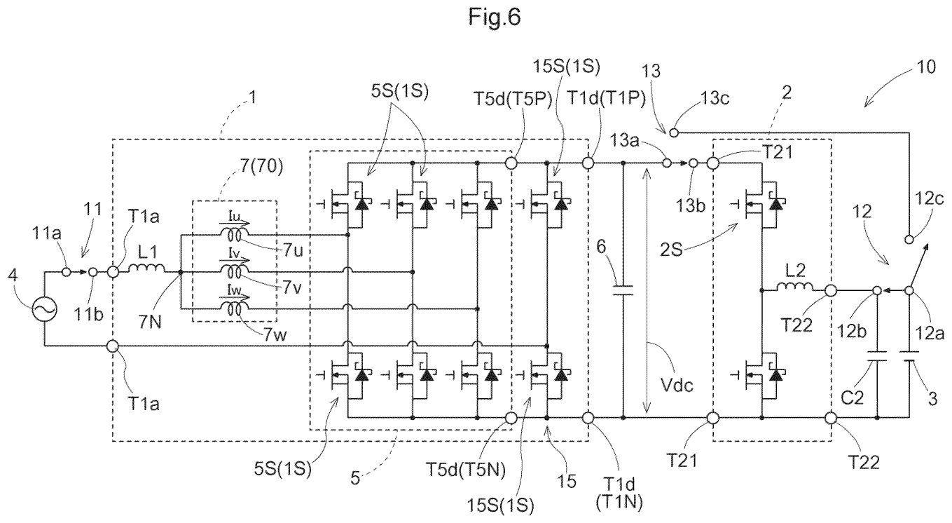

The schematic block diagram of FIG. 2 shows a system configuration of the in-vehicle charging device 10 in which the drive control system for the rotary electric machine 70 is used for either the AC-DC converter 1 or the DC-DC converter 2. In addition, it can be said that the schematic block diagram of FIG. 3 shows a system configuration of the in-vehicle charging device 10 in which the drive control system for the rotary electric machine 70 is used for the DC-DC converter 2. The block diagram of FIG. 2 corresponds to any of the in-vehicle charging device 10 of a first example to be described later with reference to FIG. 4, the in-vehicle charging device 10 of a second example to be described later with reference to FIG. 5, and the in-vehicle charging device 10 of a third example to be described later with reference to FIG. 6. The block diagram of FIG. 3 corresponds to the in-vehicle charging device 10 of the first example and the in-vehicle charging device 10 of the second example. Although details will be described later, a configuration in which the drive system circuit for the rotary electric machine 70 is used for the DC-DC converter 2 (the first example shown in FIG. 4 or the second example shown in FIG. 5) has an advantage over a configuration in which the drive system circuit for the rotary electric machine 70 is used for the AC-DC converter 1 (the third example shown in FIG. 6). From this viewpoint, the in-vehicle charging device 10 of the third example can also be referred to as a comparative example with respect to the in-vehicle charging device 10 of each of the first example and the second example.

The circuit block diagram of FIG. 4 shows a configuration example (first example) of the in-vehicle charging device 10 using the drive control system for the rotary electric machine 70, including the drive system circuit (the coils 7, the inverter 5, and the like) for the rotary electric machine 70. The circuit block diagram of FIG. 5 shows another configuration example (second example) of the in-vehicle charging device 10 using the drive control system for the rotary electric machine 70, including the drive system circuit for the rotary electric machine 70. The circuit block diagram of FIG. 6 shows another configuration example (third example) of the in-vehicle charging device 10 using the drive control system for the rotary electric machine 70, including the drive system circuit for the rotary electric machine 70. In each of the first example shown in FIG. 4 and the second example shown in FIG. 5, the AC-DC converter 1, which is a front converter connected to the external AC power supply 4, includes a circuit formed separately from the vehicle drive device 9, and the DC-DC converter 2, which is a back converter connected to the DC power supply 3, is configured by sharing the drive system circuit (the coils 7 and the inverter 5) for the rotary electric machine 70. In the third example shown in FIG. 6, the AC-DC converter 1, which is a front converter connected to the external AC power supply 4, is configured by sharing the drive system circuit (the coils 7 and the inverter 5) for the rotary electric machine 70, and the DC-DC converter 2, which is a back converter connected to the DC power supply 3, includes a circuit formed separately from the vehicle drive device 9.

As shown in FIGS. 4, 5, and 6, the AC-DC converter 1 includes switching elements 1S. In AC-DC conversion, a phase difference occurs between a voltage phase and a current phase due to inductive impedance or capacitive impedance, and a power factor decreases due to the phase difference. For example, the current phase is adjusted by controlling the switching elements 1S, compensation is made for the phase difference, and the power factor can be corrected. The AC-DC converter 1 is also configured to function as a power factor correction (PFC) circuit that corrects a power factor of DC power converted from AC power supplied from the external AC power supply 4.

In common with the first example, the second example, and the third example, the AC-DC converter 1 includes an inductor L1 and a full-bridge circuit using the switching elements 1S. As shown in FIGS. 4 and 5, in the first example and the second example, the AC-DC converter 1 has the same configuration, and the DC-DC converter 2 has different configurations. As shown in FIG. 6, the third example is apparently configured by including four arms, but the third example is also equivalently formed with the full-bridge circuit (details will be described later). The AC-DC converter 1 also having the power factor correction function includes the inductor L1, whereby inductance required for implementing the power factor correction function can be appropriately set through the inductor L1. In addition, by providing the full-bridge circuit, the AC-DC converter 1 can be caused to function as a bidirectional converter that can perform AC-DC conversion and DC-AC conversion. For example, the in-vehicle charging device 10 can be used as a device having two functions, that is, a function of charging the DC power supply 3 with power supplied from the external AC power supply 4 and a function of supplying AC power to a device outside the vehicle with power stored in the DC power supply 3.

In recent years, it has been proposed to use the DC power supply 3 of an electric vehicle or a hybrid vehicle as an emergency power supply at the time of disaster or the like. By allowing the AC-DC converter 1 to include the full-bridge circuit, the DC power supply 3 can be used as such an emergency power supply. Of course, in a case where such use of the DC power supply 3 is not considered, the AC-DC converter 1 may be configured as a unidirectional converter that performs simply AC-DC conversion. In this case, the AC-DC converter 1 may include, for example, a half-bridge circuit.

As shown in FIGS. 2 and 3, in the DC-DC converter 2, the first terminal T21 is connected to the DC-side terminal T1d of the AC-DC converter 1, and the second terminal T22 is connected to the DC power supply 3. In the first example illustratively shown in FIG. 4, the DC link terminal T5d, which is the DC-side terminal of the inverter 5, is the first terminal T21, and the neutral point 7N is the second terminal T22. In addition, in the second example illustratively shown in FIG. 5, the neutral point 7N is the first terminal T21, and the DC link terminal T5d, which is the DC-side terminal of the inverter 5, is the second terminal T22.

As shown in FIG. 4, the in-vehicle charging device 10 includes a front-end contactor 11 that selectively connects the AC-side terminal T1a of the AC-DC converter 1 and the external AC power supply 4 (connects and disconnects the AC-side terminal T1a and the external AC power supply 4). The front-end contactor 11 includes a contact (front-end contactor first contact 11a) connected to the external AC power supply 4 and a contact (front-end contactor second contact 11b) connected to the AC-DC converter 1. When the front-end contactor first contact 11a and the front-end contactor second contact 11b are connected, the front-end contactor 11 is brought into a conductive state, and the external AC power supply 4 and the in-vehicle charging device 10 (AC-DC converter 1) are electrically connected.

As shown in FIG. 4, the in-vehicle charging device 10 of the first example includes a battery contactor 12 that selectively connects the DC link terminal T5d, which is the DC-side terminal of the inverter 5, and the neutral point 7N to the DC power supply 3. In the present embodiment, the battery contactor 12 selectively connects the DC link positive terminal T5P and the neutral point 7N to the positive electrode of the DC power supply 3. The battery contactor 12 includes a battery contactor first contact 12a connected to the positive electrode of the DC power supply 3, a battery contactor second contact 12b connected to the neutral point 7N, and a battery contactor third contact 12c connected to the DC link positive terminal T5P. When the battery contactor first contact 12a and the battery contactor second contact 12b are connected, the neutral point 7N is connected to the DC power supply 3 via the battery contactor 12. The battery contactor third contact 12c is opened. When the inverter 5 functions as the in-vehicle charging device 10, the battery contactor 12 is connected in this manner.

When the inverter 5 is used for drive control of the rotary electric machine 70, the battery contactor first contact 12a and the battery contactor third contact 12c are connected, and the DC link positive terminal T5P of the inverter 5 is connected to the DC power supply 3 via the battery contactor 12. The battery contactor second contact 12b is opened. In addition, when the vehicle is parked or when it is necessary to cut off supply of power to the rotary electric machine 70 due to an abnormality or the like, a state can be formed in which neither the battery contactor second contact 12b nor the battery contactor third contact 12c is connected to the battery contactor first contact 12a.

In this manner, simply by changing the connection form with respect to the DC power supply 3 through the battery contactor 12, it is possible to obtain a circuit in which switching can be made between a function of performing drive control of the rotary electric machine 70 and a function of charging the DC power supply 3 using the external AC power supply 4. That is, the in-vehicle charging device 10 can be configured with a simple configuration.

Note that the front-end contactor 11, the battery contactor 12, and a back-end contactor 13 to be described later with reference to FIG. 6 are controlled to be opened and closed through the control device 8. Alternatively, these contactors may be controlled by the vehicle control device 90. For example, each of these contactors can be configured using a mechanical relay. The mechanical relay has high insulation properties when the contact is opened, and with the mechanical relay, it is easy to largely secure a current allowed to flow when the contact is closed. However, each of these contactors is not limited to a mechanical relay, and may be configured using a semiconductor, such as a solid-state relay.

In the in-vehicle charging device 10 of the first example described above with reference to FIG. 4, the front-end contactor 11 is disposed as a contactor that selectively connects the AC-side terminal T1a of the AC-DC converter 1 and the external AC power supply 4 (connects and disconnects the AC-side terminal T1a and the external AC power supply 4). In the in-vehicle charging device 10 of the second example shown in FIG. 4, the front-end contactor 11 is disposed as a contactor that selectively connects the DC-side terminal T1d of the AC-DC converter 1 and the neutral point 7N as the first terminal T21 of the DC-DC converter 2 (connects and disconnects the DC-side terminal T1d and the neutral point 7N as the first terminal T21).

The front-end contactor 11 includes a contact (front-end contactor first contact 11a) connected to a DC-side positive terminal T1P out of the pair of DC-side terminals T1d and a contact (front-end contactor second contact 11b) connected to the neutral point 7N. When the front-end contactor first contact 11a and the front-end contactor second contact 11b are connected, the front-end contactor 11 is brought into a conductive state, and the AC-DC converter 1 and the DC-DC converter 2 are electrically connected. More specifically, the neutral point 7N is connected to the DC-side terminal T1d (DC-side positive terminal T1P) of the AC-DC converter 1 via the front-end contactor 11. Note that it is not precluded that there is a configuration further including a contactor that selectively connects the AC-side terminal T1a of the AC-DC converter 1 and the external AC power supply 4 (contactor that connects and disconnects the AC-side terminal T1a and the external AC power supply 4).

As shown in FIG. 5, the in-vehicle charging device 10 of the second example also includes a battery contactor 12 that selectively connects the DC link terminal T5d, which is the DC-side terminal of the inverter 5, to the DC power supply 3 (connects and disconnects the DC power supply 3 and the DC link terminal T5d). The battery contactor 12 of the in-vehicle charging device 10 of the first example described above with reference to FIG. 4 is a contactor that selectively connects the DC link terminal T5d and the neutral point 7N to the DC power supply 3, and includes the battery contactor first contact 12a connected to the positive electrode of the DC power supply 3, the battery contactor second contact 12b connected to the neutral point 7N, and the battery contactor third contact 12c connected to the DC link positive terminal T5P. The battery contactor 12 of the second example does not include the battery contactor second contact 12b connected to the neutral point 7N, and includes only the battery contactor first contact 12a and the battery contactor third contact 12c. When the battery contactor first contact 12a and the battery contactor third contact 12c are connected, the DC link positive terminal T5P is connected to the DC power supply 3 via the battery contactor 12.

In the second example shown in FIG. 5, both in a case where the inverter 5 functions as the in-vehicle charging device 10 and in a case where the inverter 5 is used for drive control of the rotary electric machine 70, the battery contactor first contact 12a and the battery contactor third contact 12c are connected, and the DC link positive terminal T5P of the inverter 5 is connected to the DC power supply 3 via the battery contactor 12. That is, in the second example, both in a case where the inverter 5 functions as the in-vehicle charging device 10 and in a case where the inverter 5 is used for drive control of the rotary electric machine 70, the DC power supply 3 is connected to the inverter 5. Note that when the vehicle is parked or when it is necessary to cut off supply of power to the rotary electric machine 70 due to an abnormality or the like, the DC power supply 3 can be disconnected from the inverter 5 by bringing the battery contactor 12 into an opened state through disconnection between the battery contactor first contact 12a and the battery contactor third contact 12c.

In the first example, when viewed electrically in a direction from the AC-DC converter 1 to the DC power supply 3, the neutral point 7N is connected to the DC power supply 3 on the output side, and the coils 7 are disposed on the output side of the DC-DC converter 2. That is, the inductors (coils 7) and an output smoothing capacitor C2 are disposed on the output side of a DC-DC conversion circuit, and the DC-DC converter 2 is formed as a step-down converter. In the second example, the neutral point 7N is connected to the DC-side terminal T1d of the AC-DC converter 1, and the coils 7 are disposed on the input side of the DC-DC converter 2. That is, the inductors (coils 7) are disposed on the input side of the DC-DC conversion circuit, and the DC link terminal T5d, which is the DC-side terminal of the inverter 5, is disposed on the output side of the DC-DC conversion circuit, and the DC link capacitor 6 functions as the output smoothing capacitor C2 in the first example. Thus, the DC-DC converter 2 of the second example is formed as a step-up converter. In the second example, the DC link capacitor 6 functions as the output smoothing capacitor for the DC-DC conversion circuit, and thus a second DC link capacitor C1 is disposed between the pair of DC-side terminals T1d on the output side of the AC-DC converter 1 in order to smooth the DC voltage.

Typically, it is known that a non-isolated AC-DC converter or DC-DC converter is configured by including a switching element or an inductor (coil). As described above with reference to FIG. 1, the vehicle drive device 9 includes the inverter 5, and the coils 7 of the rotary electric machine 70. Moreover, when the DC power supply 3 is charged using the external AC power supply 4, the vehicle is stopped, and the rotary electric machine 70 is not driven. Therefore, by using the inverter 5 as a circuit with switching in the AC-DC converter 1 or the DC-DC converter 2 and by using the coils 7 as inductors, the mounting cost of the in-vehicle charging device 10 can be reduced. Further, in addition to the rotary electric machine 70, the in-vehicle charging device 10 can be added to the control target of the control device 8, and the system can be simplified. That is, as in the present embodiment, by sharing a part of the drive system circuit for the rotary electric machine 70 as a part of the in-vehicle charging device 10, the in-vehicle charging device 10 can be constructed at low cost.

As described above, in the in-vehicle charging device 10 of each of the first example and the second example, the drive system circuit for the rotary electric machine 70 is shared with the DC-DC converter 2. However, in the in-vehicle charging device 10 of the third example, the drive system circuit for the rotary electric machine 70 is shared with the AC-DC converter 1. This AC-DC converter 1 is configured with the inverter 5, the coils 7 of a plurality of phases, a single-phase arm 15 connected in parallel to the inverter 5, and the inductor L1. The coils 7 of the plurality of phases are short-circuited at the neutral point 7N, and the inductor L1 and the external AC power supply 4 are connected in series between the neutral point 7N and a middle point of the single-phase arm 15. The three-phase arms forming the inverter 5 are connected in parallel to form a single arm apparently, and form a full-bridge circuit together with the single-phase arm 15. Note that the switching element 5S forming the inverter 5 and switching elements 15S of the single-phase arm 15 are preferably elements having the same electrical specification. Since the coil 7 also has inductance, the coil 7 can be caused to function as input inductance of the AC-DC converter 1, but its value is often insufficient as described later. Therefore, the inductor L1 is also disposed similarly to the first example and the second example. The inductor L1 is denoted by the same reference sign as those of the first example and the second example because the inductor L1 has the same arrangement of being connected to the external AC power supply 4, but this does not mean that their circuit constants are the same.

In the in-vehicle charging device 10 of the third example, the DC-DC converter 2 is formed independently without sharing the drive system circuit for the rotary electric machine 70. The DC-DC converter 2 includes an arm in which switching elements 2S are connected in series to be subjected to complementary switching control, and a back-end inductor L2 connected to a middle point of the arm, and is configured as a step-down DC-DC converter. In the first example and the second example, the coils 7 of the rotary electric machine 70 are used as inductors of the DC-DC converter 2. In the third example, the coils 7 are used in the AC-DC converter 1, and thus the back-end inductor L2 is additionally disposed. Note that the DC-DC converter 2 may be configured as a step-up converter or a step-up/step-down converter.

The in-vehicle charging device 10 of the third example includes a front-end contactor 11 and a battery contactor 12 similar to those of the in-vehicle charging device 10 of the first example. The connection form and the opening and closing control are similar to those in the in-vehicle charging device 10 of the first example, and thus description thereof will be omitted. In addition, the in-vehicle charging device 10 of the third example also includes the back-end contactor 13 that selectively connects the AC-DC converter 1 (inverter 5) and the DC power supply 3, or selectively connects the AC-DC converter 1 (inverter 5) and the DC-DC converter 2. The back-end contactor 13 includes a back-end contactor first contact 13a connected to a positive terminal of the AC-DC converter 1 (inverter 5), a back-end contactor second contact 13b connected to a positive terminal on the input side of the DC-DC converter 2, and a back-end contactor third contact 13c connected to the battery contactor third contact 12c and selectively connected to the positive electrode of the DC power supply 3. When the back-end contactor first contact 13a and the back-end contactor second contact 13b are connected, the AC-DC converter 1 (inverter 5) and the DC-DC converter 2 are connected.

When the inverter 5 is used for drive control of the rotary electric machine 70, the battery contactor first contact 12a and the battery contactor third contact 12c are connected as described above with reference to FIG. 4. In this state, when the back-end contactor first contact 13a and the back-end contactor third contact 13c are connected, the inverter 5 and the DC power supply 3 are connected via the back-end contactor 13 and the battery contactor 12.

Incidentally, the rotary electric machine serving as a driving power source for a vehicle is designed to have high power density, and has small inductance. Moreover, when the same current flows through the coils 7 of three phases, magnetic saturation is likely to occur, and inductance in the coil 7 is likely to be small. Therefore, in a case where, as in the in-vehicle charging device 10 of the third example, the AC-DC converter 1 is formed by connecting the single-phase external AC power supply 4 to the neutral point 7N, a peak value of a harmonic current in the system current of the external AC power supply 4 tends to increase at the time of AC-DC conversion. In addition, it is also conceivable that the peak value of a ripple current after DC conversion increases. In the in-vehicle charging device 10 of the third example, in order to complement the inductance of the coil 7, the inductor L1 is disposed between the external AC power supply 4 and the neutral point 7N of the coils 7 of the plurality of phases, thereby obtaining required inductance.

As another method, it is also conceivable to increase control frequency of the inverter 5 included in the AC-DC converter 1 or the DC-DC converter 2 without connecting an additional inductor L1 to the coil 7. Of course, the inductor L1 may be connected and the control frequency may be increased. However, when the control frequency is increased, it is necessary to shorten a control period (control frequency) of the control device 8 that controls the inverter 5 or the DC-DC converter 2. Switching at a high frequency increases loss in switching elements included in the AC-DC converter 1 (inverter 5) and the DC-DC converter 2, and thus this may lead to a decrease in efficiency of the in-vehicle charging device 10. In addition, it is necessary to use a microcomputer or the like that can operate at a high speed as the control device 8, which may lead to an increase in cost of the in-vehicle charging device 10.

In the in-vehicle charging device 10 of each of the first example and the second example, the coils 7 are used not in the AC-DC converter 1 but in the DC-DC converter 2, and thus it is easy to reduce an increase in system cost of the in-vehicle charging device 10, as compared with the in-vehicle charging device 10 of the third example. That is, in each of the first example and the second example, out of the AC-DC converter 1 and the DC-DC converter 2 forming the in-vehicle charging device 10, the AC-DC converter 1 requiring appropriate inductance is configured without using the drive system circuit for the rotary electric machine 70 (the coils 7 of the rotary electric machine 70 and the inverter 5 that drives the rotary electric machine 70). When the coil 7 of the rotary electric machine 70 is used in the in-vehicle charging device 10, there is a case in which it is difficult to obtain required performance due to small inductance of the coil 7. However, in each of the first example and the second example, with the AC-DC converter 1 that does not use the coil 7 and in which appropriate inductance is settable, the AC-DC converter 1 that can perform AC-DC conversion while obtaining sufficient performance such as a power factor correction function can be configured. In addition, the DC-DC converter 2 not requiring high inductance can be configured by sharing the drive system circuit for the rotary electric machine 70, and the cost of the in-vehicle charging device 10 can be reduced. Further, since appropriate inductance is settable in the AC-DC converter 1, it is unnecessary to control the AC-DC converter 1 at a short control period (high control frequency), and it is also easy to reduce loss in the switching element 1S forming the AC-DC converter 1. Therefore, the system efficiency of the in-vehicle charging device 10 is also easily increased.

As described above, in particular, according to the in-vehicle charging device 10 of each of the first example and the second example, it is possible to configure, while reducing an increase in system cost, the in-vehicle charging device 10 that charges the DC power supply 3 of the vehicle drive device 9 including the rotary electric machine 70, the inverter 5, and the DC power supply 3, with power from the external AC power supply 4, using the coils 7 of the rotary electric machine 70 and the inverter 5.

A preferred charging method (in-vehicle charging method) for the DC power supply 3 using the in-vehicle charging device 10 as described above will be described below. This in-vehicle charging method is applicable to any of the in-vehicle charging devices 10 of the first example, the second example, and the third example. Note that, of course, the in-vehicle charging device 10 of each of the first example, the second example, and the third example may be configured while including the control device 8 that performs control using this charging method. A configuration using the in-vehicle charging device 10 of the first example will be described below as atypical example. When the in-vehicle charging device 10 of each of the second example and the third example is used, there is a difference from the following description of the case of using the first example due to the difference in the circuit configuration. However, those skilled in the art can make replacement as appropriate, and thus detailed description thereof will be omitted.

As a control method used in charging the DC power supply 3 with power supplied from the external AC power supply 4 while preventing overcharge (overvoltage) of the DC power supply 3, using the in-vehicle charging device 10 as described above, constant-current constant-voltage charging control as illustratively shown in FIG. 8 is known. In the constant-current constant-voltage charging control, when a state of charge (SOC) of the DC power supply 3 is low, the DC power supply is charged by constant current charging control for supplying a constant current to the DC power supply 3. A constant value of a current (battery current Ibat) flows through the DC power supply 3. In FIG. 8, a first phase PH1 corresponds to a period of time during which the constant current charging control is performed. As charging through the constant current charging control progresses, the value of the SOC increases, and a terminal voltage (battery voltage Vbat) of the DC power supply 3 also increases from a voltage at the start of charging (charging start voltage Vbat_e).

When the SOC increases to a predetermined value (for example, 80 to 90%) or when the battery voltage Vbat increases to a preset value (switching voltage Vbat_s), the control method is switched from the constant current charging control to constant voltage charging control. In FIG. 8, a second phase PH2 corresponds to a period of time during which the constant voltage charging control is performed. In the constant voltage charging control, charging is continued while a voltage applied to the DC power supply 3 is kept constant. Since the voltage applied to the DC power supply 3 is kept constant, the battery current Ibat gradually decreases. The battery voltage Vbat increases while slowing the increasing rate. When the battery voltage Vbat increases to a predetermined value (for example, the fully charged voltage Vbat_f), when the battery current Ibat decreases to a predetermined value, or when the SOC increases to a predetermined value (for example, 98 to 100%), the constant voltage charging control ends, and the charging control also ends.

Incidentally, as described above, in the present embodiment, the DC power supply 3 is charged by using the in-vehicle charging device 10 using the drive system circuit (the coils 7, the inverter 5, and the like) for the rotary electric machine 70. As shown in FIG. 2 and the like, a smoothing capacitor is disposed between the AC-DC converter 1 and the DC-DC converter 2 (the “DC link capacitor 6” in the first example (FIG. 4) or in the third example (FIG. 6), and the “second DC link capacitor C1” in the second example (FIG. 5); hereinafter, referred to as the “DC link capacitor 6” as appropriate because the first example is described as a typical example). Moreover, typically, as shown in FIG. 8, the DC link voltage Vdc corresponding to the terminal voltage of the DC link capacitor 6 is kept at a constant voltage value over the entire period of time of the constant-current constant-voltage charging control. As described above, the battery voltage Vbat is a low value (Vbat_e) at the start time of the charging control at which the SOC is low, and increases with the progress of the constant current charging control. Therefore, at the start of the charging control, a voltage difference between the DC link voltage Vdc and the battery voltage Vbat is large, and loss such as switching loss in the in-vehicle charging device 10 (in this case, in particular, the DC-DC converter 2) tends to increase. In addition, in the constant current charging control, the battery voltage Vbat increases with the progress of the control. Since the battery current Ibat is constant, as shown in FIG. 8, battery power Pbat is small at the beginning of the charging control (constant current charging control), and increases with the progress of the constant current charging control. That is, the DC power supply 3 is not charged with the maximum allowable charging power, and thus the charging time tends to be long.

In view of this point, in the present embodiment, the in-vehicle charging device 10 (in-vehicle charging method) that can perform charging with high efficiency as compared with the conventional constant-current constant-voltage charging control is provided. As shown in FIG. 7, until the terminal voltage (battery voltage Vbat) of the DC power supply 3 reaches the switching voltage Vbat_s from a state lower than the switching voltage Vbat_s (for example, the charging start voltage Vbat_e), the control device 8 performs, as charging control, constant power charging control such that charging power (battery power Pbat) based on the current (battery current Ibat) flowing through the DC power supply 3 and the terminal voltage (battery voltage Vbat) of the DC power supply 3 is constant (first phase PH1). In addition, in the constant power charging control, the control device 8 performs variable DC voltage control such that the terminal voltage (DC link voltage Vdc) of the DC link capacitor 6 increases in accordance with an increase in the terminal voltage (battery voltage Vbat) of the DC power supply 3.

Further, the control device 8 performs, as the charging control, variable power charging control under which the battery power Pbat is caused to gradually decrease such that the battery power Pbat decreases in accordance with an increase in the battery voltage Vbat, after the battery voltage Vbat has reached the switching voltage Vbat_s and until the battery voltage Vbat reaches the fully charged voltage Vbat_f, until the battery current Ibat decreases to a predetermined value, or until the SOC increases to a predetermined value (for example, 98 to 100%) (second phase PH2). Preferably, in the variable power charging control, the control device 8 decreases the battery power Pbat to zero, or decreases the battery current Ibat to zero.

Note that the fully charged voltage Vbat_f that is the terminal voltage (battery voltage Vbat) of the DC power supply 3 exhibited when the DC power supply 3 is in a fully charged state corresponds to a “first voltage”, and the switching voltage Vbat_s corresponds to a “second voltage” that is a voltage lower than the “first voltage” and preset. In addition, the charging start voltage Vbat_e that is lower than the “second voltage” and that is the battery voltage Vbat at the start of charging can also be referred to as a “third voltage”. The fully charged voltage Vbat_f and the switching voltage Vbat_s are voltage values predetermined according to the specifications of the DC power supply 3. On the other hand, the charging start voltage Vbat_e is any value at the time of charging, is a value that varies, and is not a predetermined voltage value.

If the charging control is continued while keeping the charging power (battery power Pbat) constant, the charging may be performed with the same power even when the terminal voltage (battery voltage Vbat) of the DC power supply 3 approaches the first voltage (fully charged voltage Vbat_f), and the current may be continuously supplied to the DC power supply 3, which may lead to a risk of overcharge. By performing the variable power charging control after the terminal voltage of the DC power supply 3 has reached the second voltage (switching voltage Vbat_s), such overcharge is easily prevented.

Note that the control device 8 performs, as the charging control, the constant voltage charging control described above with reference to FIG. 8 instead of the variable power charging control, after the battery voltage Vbat has reached the switching voltage Vbat_s and until the battery voltage Vbat reaches the fully charged voltage Vbat_f, until the battery current Ibat decreases to a predetermined value, or until the SOC increases to a predetermined value (for example, 98 to 100%).

As shown in FIG. 7, in the charging control of the present embodiment, when the state of charge (SOC) of the DC power supply 3 is low, the constant power charging control is performed such that the battery power Pbat is constant. In FIG. 7, the first phase PH1 corresponds to a period of time during which the constant power power charging control is performed. The battery power Pbat is a product of the battery current Ibat and the battery voltage Vbat. Immediately after the start of the charging control, the battery voltage Vbat is a low voltage, and thus the DC power supply 3 can be charged by causing the battery current Ibat having a current value larger than the current value of the battery current Ibat in the constant current charging control to flow. As described above, the battery voltage Vbat increases with the progress of charging, and thus the battery current Ibat decreases with the charging control when the battery power Pbat is constant. In addition, as described above, when the constant power charging control is performed, the variable DC voltage control is also performed such that the DC link voltage Vdc increases in accordance with an increase in the battery voltage Vbat, in parallel. The DC link voltage Vdc is controlled such that the DC link voltage Vdc becomes a voltage higher than the battery voltage Vbat by a substantially constant difference voltage while being parallel to the battery voltage Vbat.

When the SOC increases to a predetermined value (for example, 80 to 90%) or when the battery voltage Vbat increases to a preset value (switching voltage Vbat_s), the control method is switched from the constant power charging control to the variable power charging control. In FIG. 7, the second phase PH2 corresponds to a period of time during which the variable power charging control is performed. In the variable power charging control, the variable DC voltage control is not performed, and the DC link voltage Vdc is kept at a substantially constant voltage. Therefore, in the variable power charging control, charging is continued while the voltage applied to the DC power supply 3 is substantially kept constant. The battery voltage Vbat increases while slowing the increasing rate. The battery current Ibat decreases at a rate of change higher than the rate of change of the battery voltage Vbat, and the battery power Pbat also decreases. When the battery voltage Vbat increases to a predetermined value (for example, the fully charged voltage Vbat_f), when the battery current Ibat decreases to a predetermined value (zero or near zero), when the battery power Pbat decreases to a predetermined value (zero or near zero), or when the SOC increases to a predetermined value (for example, 98 to 100%), the variable power charging control ends, and the charging control also ends.

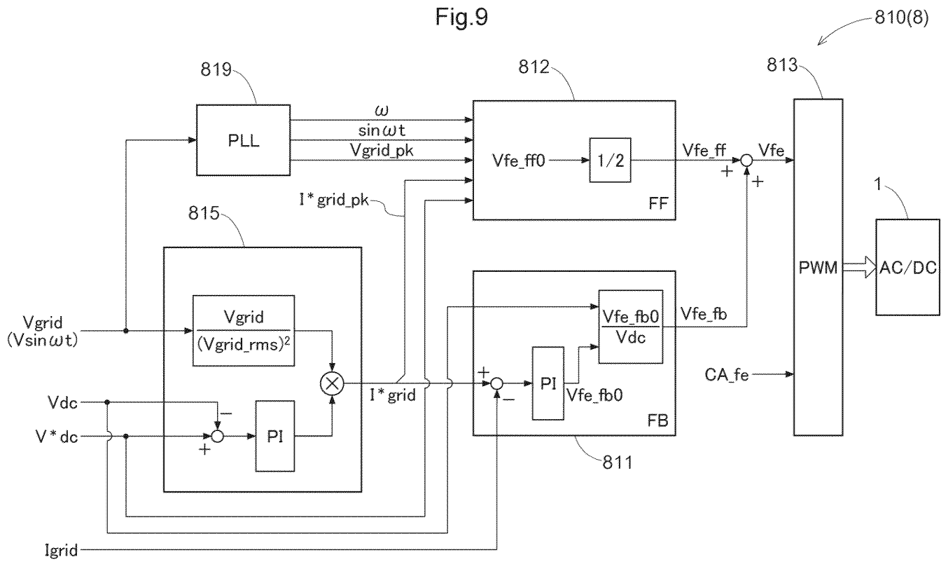

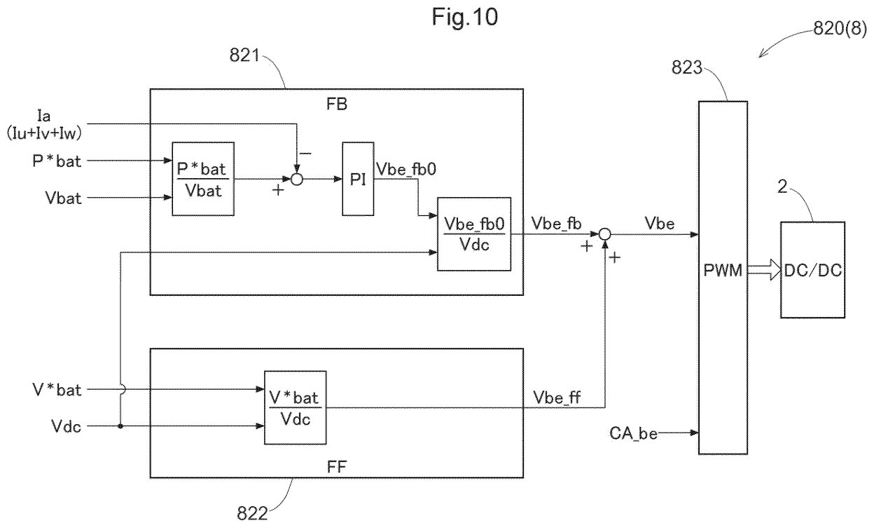

A control mode in the control device 8 for implementing the constant power charging control, the variable power charging control, and the variable DC voltage control will be described below. FIG. 9 is a schematic control block diagram of a front-end control part 810 that controls the AC-DC converter 1 (front converter). FIG. 10 is a schematic control block diagram of a back-end control part 820 that controls the DC-DC converter 2 (back converter).

In FIG. 6, a “grid voltage Vgrid” is an AC voltage input from the external AC power supply 4 and denoted by “V sin ωt”. Here, “ω” is an angular velocity, and “t” is time. Note that, here, a case is exemplified in which the control device 8 performs sine wave control, instead of performing vector control in a d-p-axis vector coordinate system. In the case of the vector control, the grid voltage Vgrid is denoted by “V cos ωt”. In addition, a “grid current Igrid” is an AC current input from the external AC power supply 4. “V*dc” is a command value of the DC link voltage Vdc. In the variable DC voltage control described above, the value of the DC link voltage Vdc is variably controlled. As is apparent also from FIG. 4, the DC link voltage Vdc is a voltage output from the AC-DC converter 1, and thus the AC-DC converter 1 is controlled by the control device 8 on the basis of the DC link voltage command V*dc.

As shown in FIG. 9, the front-end control part 810 includes a grid current command calculation part 815, a front-end feedback calculation part 811, a front-end feedforward calculation part 812, a front-end pulse generation part 813, and a grid voltage detection part 819. The front-end control part 810 performs calculation using information detected by the grid current sensor 41, the grid voltage sensor 42, the DC link voltage sensor 61, and the like described above.

The grid voltage detection part 819 detects a peak voltage (grid voltage peak value Vgrid_pk), an angular velocity ω, and a waveform “sin ωt” from the grid voltage Vgrid, in order to use these in a control block at a subsequent stage. The present embodiment exemplifies a configuration in which the grid voltage detection part 819 is configured using a phase locked loop (PLL). As described above, in the case of the vector control, “cos ωt” is detected as the waveform.

The grid current command calculation part 815 calculates a power value by performing proportional-integral control (PI control) on the basis of a deviation between the DC link voltage Vdc and the DC link voltage command V*dc, and calculates a grid current command I*grid on the basis of this power value and the grid voltage Vgrid. As shown in FIG. 9, a product of a value obtained by dividing the grid voltage Vgrid by the square of a root-mean-square value of the grid voltage Vgrid (grid voltage root-mean-square value Vgrid_rms) and the calculation result of the PI control based on the deviation of the DC link voltage Vdc is the grid current command I*grid.

The front-end feedback calculation part 811 performs proportional-integral control (PI control) on the basis of a deviation between the grid current Igrid and the grid current command I*grid to calculate a front-end feedback voltage command Vfe_fb0. In addition, the front-end feedback calculation part 811 calculates a front-end feedback duty Vfe_fb by dividing the front-end feedback voltage command Vfe_fb0 by the DC link voltage Vdc.

The front-end feedforward calculation part 812 calculates a front-end feedforward duty Vfe_ff. Here, in order to generate a sinusoidal voltage command, the magnitude (amplitude or peak value) and the phase of the wave are calculated. The magnitude of the voltage command is defined by a ratio between an input voltage and an output voltage (input voltage Vin/output voltage Vout), and is calculated by dividing the grid voltage peak value Vgrid_pk by the DC link voltage command V*dc. The phase is determined in consideration of three factors, that is, a phase “ωt” of the grid voltage Vgrid, a phase delay (referred to as “θ1”) caused by the inductor L1, and a phase delay (referred to as “θ2”) accompanying a delay of grid current control. Note that the delay of the grid current control corresponds to a delay time accompanying a situation in which the grid current command I*grid is calculated in one control period of the control device 8 after the grid current Igrid is detected, and in which the AC-DC converter 1 is controlled by a voltage command calculated in the next control period.

The phase delay “θ1” caused by the inductor L1 is expressed by the following equation, where the inductance of the inductor L1 is “L”. Note that “I*grid_pk” is a grid current command peak value.

$$θ 1 = - {I}^{*} grid\_pk \cdot ( ( ω L / Vgrid\_pk )$$

The phase delay “θ2” accompanying the delay of the grid current control is calculated as follows, as a phase corresponding to 1.5 periods because a delay corresponding to 1 period of the control period occurs in the calculation of the voltage command. Here, by performing the correction for the equivalent of 1.5 periods, it is possible to correct an average voltage in the entire carrier period that is 1 period later at which the control calculation result is reflected.

$$θ2 = ω \cdot ( time for 1.5 periods of grid current control / 1 [ s ]$$

On the basis of these, a sinusoidal front-end feedforward voltage command Vfe_ff0 is defined as follows.

$$Vfe\_ff0 = 1 - ( Vgrid\_k / {V}^{*} dc ) sin ( ( ω t - θ 1 + θ 2 )$$

Since a normal sine wave has positive and negative values with zero as an amplitude center, known conversion processing or the like for generating a pulse with a positive digital value, such as shift processing, is performed. Note that in the calculation example described above, since the front-end feedforward voltage command Vfe_ff0 is calculated in an offset state so as not to have a negative value, it is simply necessary to adjust the amplitude. A controller of “½” in the front-end feedforward calculation part 812 in FIG. 9 is an amplitude adjuster, and the front-end feedforward duty Vfe_ff is generated through this amplitude adjuster

$$Vfe\_ff = Vfe\_ff0 / 2$$

The front-end pulse generation part 813 generates a pulse (pulse for pulse width modulation) for performing switching control on the switching element 1S forming the AC-DC converter 1, on the basis of a final duty (front-end duty Vfe) obtained by adding the front-end feedback duty Vfe_fb and the front-end feedforward duty Vfe_ff. The front-end duty Vfe is obtained as follows.

$$Vfe = Vfe\_fb + Vfe\_ff$$

The front-end duty Vfe corresponds to a duty in pulse width modulation control. The final switching pulse is generated through known calculation based on a carrier wave (front-end carrier CA_fe) and the front-end duty Vfe, and thus detailed description thereof will be omitted.

Note that, here, in order to facilitate understanding, the mode with the sine wave control has been described as an example. However, it is also possible to construct the front-end control part 810 such that calculation is performed in the d-q-axis vector coordinate system. Those skilled in the art can easily make replacement of the control block diagram of FIG. 9, and thus detailed description thereof will be omitted here.

In FIG. 10, “Ia” denotes a “coil current” that is the sum of currents flowing through the coils 7 of a plurality of phases. In the present embodiment, the coils 7 of three phases are provided, and in the configuration illustratively shown in FIG. 4, the coil current Ia is the sum of the U-phase current Iu, the V-phase current Iv, and the W-phase current Iw. “P*bat” is a command value (battery power command) of the battery power Pbat in the constant power charging control. “V*bat” is a command value (battery voltage command) of the battery voltage Vbat.

As shown in FIG. 10, the back-end control part 820 includes a back-end feedback calculation part 821, a back-end feedforward calculation part 822, and a back-end pulse generation part 823. The back-end control part 820 performs calculation using information detected by the motor current sensor 81, the battery current sensor 31, the battery voltage sensor 32, the DC link voltage sensor 61, and the like described above. Note that the battery power Pbat can be obtained by obtaining a product of the battery current Ibat and the battery voltage Vbat.

The back-end feedback calculation part 821 performs proportional-integral control (PI control) on the basis of a deviation between a battery current command (I*bat) obtained by dividing the battery power command P*bat by the battery voltage Vbat and the coil current Ia corresponding to a current flowing to the DC power supply 3 (battery current Ibat) to calculate a back-end feedback voltage command Vbe_fb0. In addition, the back-end feedback calculation part 821 calculates a back-end feedback duty Vbe_fb by dividing the back-end feedback voltage command Vbe_fb0 by the DC link voltage Vdc.

The back-end feedforward calculation part 822 calculates a back-end feedforward duty Vbe_ff. The back-end feedforward duty Vbe_ff is defined by a ratio between an input voltage and an output voltage (input voltage Vin/output voltage Vout), and the back-end feedforward calculation part 822 calculates the back-end feedforward duty Vbe_ff by dividing the battery voltage command V*bat by the DC link voltage Vdc.

The back-end pulse generation part 823 generates a pulse (pulse for pulse width modulation) for performing switching control on the switching element 5S, of the inverter 5, which is a switching element forming the DC-DC converter 2, on the basis of a back-end duty Vbe that is a sum of the back-end feedback duty Vbe_fb and the back-end feedforward duty Vbe_ff. The back-end duty Vbe corresponds to a duty in pulse width modulation control. The final switching pulse is generated through known calculation based on a carrier wave (back-end carrier CA be) and the back-end duty Vbe, and thus detailed description thereof will be omitted.

Note that as shown in FIG. 4, when the DC-DC converter 2 is configured using the inverter 5, there are six switching elements 5S to be controlled. However, as described above, since the neutral point 7N of the coils 7 is connected to the positive electrode of the DC power supply 3, the arms of three phases of the inverter 5 can be considered as one arm. Therefore, the switching elements 5S of respective phases on the upper stage side can be controlled by the same switching pulse, and the switching elements 5S on the lower stage side can be controlled by the same switching pulse.

As described above with reference to FIG. 4, the in-vehicle charging device 10 includes the front-end contactor 11 that selectively connects the AC-side terminal T1a of the AC-DC converter 1 and the external AC power supply 4 (connects and disconnects the AC-side terminal T1a and the external AC power supply 4). The in-vehicle charging device 10 includes the battery contactor 12 that selectively connects the DC link terminal T5d, which is the DC-side terminal of the inverter 5, and the neutral point 7N to the DC power supply 3. When performing charging control, the control device 8 closes the front-end contactor 11, and controls the battery contactor 12 such that the battery contactor first contact 12a and the battery contactor second contact 12b are connected. At this time, for example, in a case where the vehicle is in a stopped state for long hours, the DC link capacitor 6 is discharged, and the DC link voltage Vdc becomes substantially zero. Here, when the charging control is started, a large current transiently flows in to charge the DC link capacitor 6. In the case of the configuration illustratively shown in FIG. 4, since the AC-DC converter 1 is used only for charging, the switching element 1S forming the AC-DC converter 1 is not required to have performance that allows such a large current as to drive the rotary electric machine 70. That is, it is not preferable to allow a transient current (so-called inrush current) for charging the DC link capacitor 6 to flow through an element not having high current tolerance.

Therefore, in the present embodiment, the control device 8 performs precharging control under which the DC link capacitor 6 (smoothing capacitor) is charged, before performing the charging control.

Electric charge stored in the DC link capacitor 6 serving as a smoothing capacitor gradually decreases with discharging, after electrical connection between a supply source of the electric charge and the DC link capacitor 6 is cut off. When charging control is started from a state in which the DC link capacitor 6 is almost completely discharged, the DC link capacitor 6 is rapidly charged. That is, a large current transiently flows into a path from the supply source of the electric charge to the DC link capacitor 6 at the start of the charging control. A steady current flowing through the path while the charging control is being performed is much smaller than such a transient current, and thus it is necessary to take measures such as increasing an allowable value of a current allowed to flow through the path in preparation for such a transient current, which may lead to an increase in the device size. When the precharging control for charging the DC link capacitor 6 is performed before the charging control, it is possible to prevent a large transient current from flowing along with the start of the charging control, and it is easy to simplify the in-vehicle charging device 10 in its configuration.

As described above, the control device 8 performs the precharging control under which the DC link capacitor 6 is charged, before performing the charging control. At this time, the control device 8 preferably performs the precharging control such that electric charge is supplied to the DC link capacitor 6 through a path different from the path through which the electric charge is supplied to the DC link capacitor 6 at the time of performing the charging control.

As described above, the in-vehicle charging device 10 includes the battery contactor 12, which is a contactor that selectively connects the DC link terminal T5d, which is the DC-side terminal of the inverter 5, and the second terminal T22 of the DC-DC converter 2 to the DC power supply 3. In the precharging control, the control device 8 controls the battery contactor 12 such that the DC power supply 3 and the DC link terminal T5d are connected, and in the charging control, the control device 8 controls the battery contactor 12 such that the DC power supply 3 and the second terminal T22 of the DC-DC converter 2 are connected. Note that while the precharging control is being performed, the front-end contactor 11 is controlled to be in an opened state.

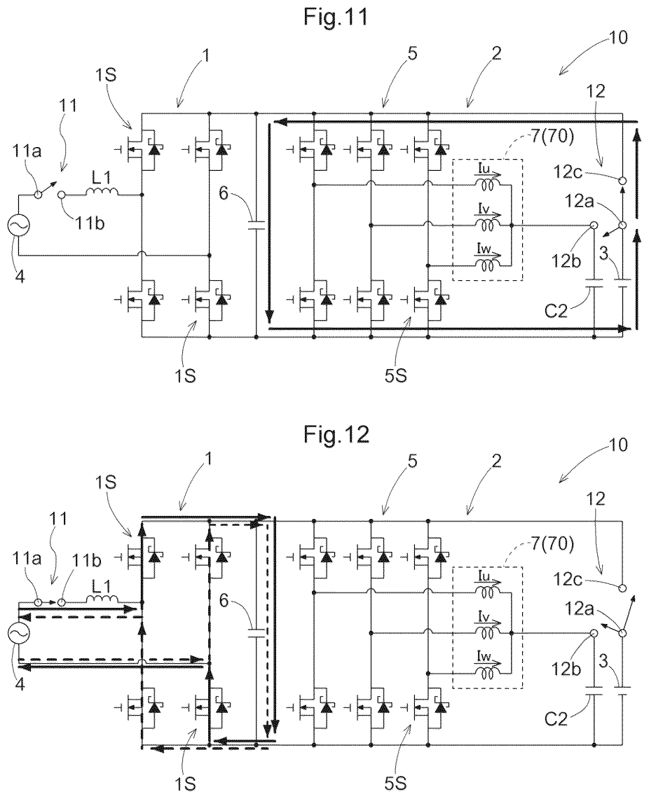

As shown in FIG. 11, in the precharging control, when the battery contactor 12 is controlled such that the DC power supply 3 and the DC link terminal T5d are connected, the DC power supply 3 and the DC link capacitor 6 are directly connected, and the DC link capacitor 6 is charged by the DC power supply 3. Since an element such as a switching element is not interposed in this path, the DC link capacitor 6 can be charged safely and quickly. Note that, although the DC power supply 3 is in a state where the SOC is lowered to such an extent that charging control is required, a level of electric charge allowing the DC link capacitor 6 to be charged often remains. Therefore, the DC link capacitor 6 can be appropriately charged.

The DC link capacitor 6 is disposed between the AC-DC converter 1 and the DC-DC converter 2, and is connected between positive and negative terminals of the DC-side terminals (DC link terminals T5d) of the inverter 5. By connecting the DC power supply 3 and the DC-side terminal of the inverter 5 through the battery contactor 12, electric charge can be directly supplied from the DC power supply 3 to the DC link capacitor 6 in the precharging control. In the path from the DC power supply 3 to the DC link capacitor 6, a component (such as a switching element) for which it is necessary to consider the magnitude of a current allowed to flow therethrough is not disposed, and thus the smoothing capacitor can be charged safely and quickly with a simple configuration.

Here, an example of a start sequence that is a sequence at the start of integrated charging control including the precharging control will be described. The integrated charging control is control in which the precharging control and the charging control are combined. Before the start of the integrated charging control, the battery contactor 12, the front-end contactor 11, all the switching elements 1S of the AC-DC converter 1, and all the switching elements 2S of the DC-DC converter 2 are in an off state. When the integrated charging control is started, the control device 8 first controls the battery contactor first contact 12a and the battery contactor third contact 12c of the battery contactor 12 to be closed. As a result, as shown in FIG. 11, the DC link capacitor 6 is charged by the DC power supply 3. When the SOC of the DC power supply 3 is low, the DC link voltage Vdc increases to a voltage that is lower than a battery voltage Vbat at the time of full charge. For example, the control device 8 can determine, on the basis of the detection result of the DC link voltage sensor 61, the end of the precharging control on the basis of the fact that the DC link voltage Vdc reaches the battery voltage Vbat and the voltage does not increase.

Next, the control device 8 starts charging control. Specifically, the control device 8 controls the front-end contactor 11 and the battery contactor 12 to cause the front-end contactor first contact 11a and the front-end contactor second contact 11b to be connected, and cause the battery contactor first contact 12a and the battery contactor second contact 12b to be connected. The control device 8 may control the front-end contactor 11 and the battery contactor 12 at the same timing, or may control them in a sequential order. When the control device 8 controls the contactors in a sequential order, any contactor may be controlled first. Incidentally, in the battery contactor 12, the battery contactor second contact 12b and the battery contactor third contact 12c are exclusively connected to the battery contactor first contact 12a. Therefore, when causing the battery contactor first contact 12a and the battery contactor second contact 12b to be connected after the precharging control, the control device 8 causes connection between the battery contactor first contact 12a and the battery contactor third contact 12c to be opened and causes the battery contactor first contact 12a and the battery contactor second contact 12b to be connected. In addition, as described above, the control device 8 may determine the end of the precharging control on the basis of the fact that the DC link voltage Vdc reaches the battery voltage Vbat and the voltage does not increase, and may control all the contacts of the battery contactor 12 to be in an opened state by opening the connection between the battery contactor first contact 12a and the battery contactor third contact 12c in advance.

After the control device 8 causes the front-end contactor first contact 11a and the front-end contactor second contact 11b to be connected and causes the battery contactor first contact 12a and the battery contactor second contact 12b to be connected, the control device 8 starts switching control of the AC-DC converter 1. The DC link voltage Vdc increases from the battery voltage Vbat to a target voltage of the DC link voltage Vdc in the charging control, with power supplied from the external AC power supply 4 via the AC-DC converter 1. When determining that the DC link voltage Vdc has reached the target voltage on the basis of the detection result of the DC link voltage sensor 61, the control device 8 starts switching control of the DC-DC converter 2.

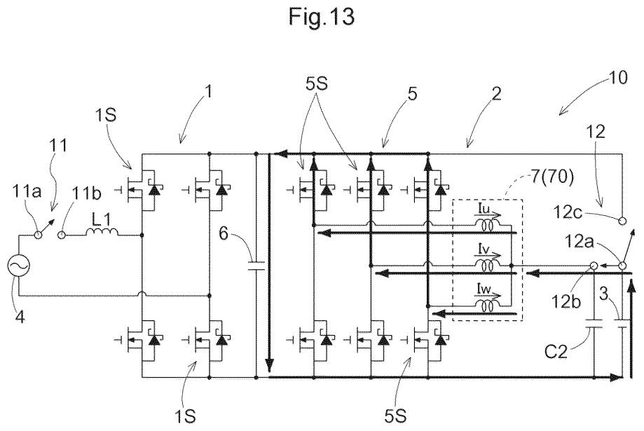

FIGS. 12 and 13 illustratively show, as comparative examples, respective cases in each of which the DC link capacitor 6 is charged through a path different from the path in FIG. 11. In the example of FIG. 12, the front-end contactor 11 is closed, and any contacts of the battery contactor 12 are opened. In this case, the AC-DC converter 1 functions as a diode full-wave rectifier circuit with the freewheeling diodes included in the switching elements 1S of the AC-DC converter 1. As a result, a transient charging current flows from the external AC power supply 4 to the DC link capacitor 6 through the switching element 1S (freewheeling diode).

Since the AC-DC converter 1 is used only for charging the DC power supply 3, the AC-DC converter 1 includes the switching elements each having a smaller value of a current allowed to flow therethrough than that of the inverter 5 that drives the rotary electric machine 70. For this reason, it is not preferable to allow such a current to flow even if the current is a transient current. However, although the component cost increases, it is not precluded that the path as illustratively shown in FIG. 12 is formed by configuring the AC-DC converter 1 using switching elements each having a large value of a current allowed to flow therethrough and thereby the precharging control is performed. In addition, in a case where the AC-DC converter 1 is configured to allow charging of the DC link capacitor 6 in the path illustratively shown in FIG. 12, the control device 8 may perform the charging control without performing the precharging control.

In the example of FIG. 13, the front-end contactor 11 is opened, and in the battery contactor 12, the battery contactor first contact 12a and the battery contactor second contact 12b are connected similarly to the case in which the charging control is performed. In this case, a transient charging current flows through the DC link capacitor 6 through the freewheeling diodes included in the switching elements 5S of the inverter 5 forming the DC-DC converter 2. Since the switching element 5S of the inverter 5 drives the rotary electric machine 70, the switching element 5S has a large value of a current allowed to flow therethrough. Therefore, from the viewpoint of the magnitude of the current, it is considered that the DC link capacitor 6 can be charged through this path. However, according to a simulation performed by the inventors, it was observed that the coil current Ia and the DC link voltage Vdc greatly oscillated at the start of the precharging control, and that the peak value increased. Therefore, as compared with the precharging control via the DC-DC converter 2 as shown in FIG. 13, it is preferable to perform precharging control by directly connecting the DC power supply 3 and the DC link capacitor 6, without via the DC-DC converter 2, as shown in FIG. 11.

The embodiments of the in-vehicle charging device (10) and the in-vehicle charging method described above will be briefly summarized below.

As one aspect, an in-vehicle charging device (10) is an in-vehicle charging device (10) configured to charge a DC power supply (3) of a vehicle drive device (9) with power supplied from an external AC power supply (4), the vehicle drive device (9) including: a rotary electric machine (70) including coils (7) of a plurality of phases connected to each other at a neutral point (7N), the rotary electric machine (70) serving as a driving power source for a wheel; an inverter (5) configured to convert power between direct current and alternating current of a plurality of phases; and the DC power supply (3) connected to the inverter (5), the in-vehicle charging device (10) including: an AC-DC converter (1) configured to convert AC power from the external AC power supply (4) into DC power; and a DC-DC converter (2) configured with the inverter (5) and the coils (7) of a plurality of phases, one of a DC-side terminal of the inverter (5) and the neutral point (7N) of the coils (7) of a plurality of phases being a first terminal (T21) of the DC-DC converter (2) and another one of the DC-side terminal of the inverter (5) and the neutral point (7N) of the coils (7) of a plurality of phases being a second terminal (T22) of the DC-DC converter (2), in which an AC-side terminal (T1a) of the AC-DC converter (1) is connected to the external AC power supply (4), a DC-side terminal (T1d) of the AC-DC converter (1) is connected to the first terminal (T21) of the DC-DC converter (2), and the second terminal (T22) of the DC-DC converter (2) is connected to the DC power supply (3).

According to this configuration, out of the AC-DC converter (1) and the DC-DC converter (2) forming the in-vehicle charging device (10), the AC-DC converter (1) requiring appropriate inductance is configured without using a drive system circuit for the rotary electric machine (70) (the coils (7) of the rotary electric machine (70) and the inverter (5) that drives the rotary electric machine (70)). When the coil (7) of the rotary electric machine (70) is used in the in-vehicle charging device (10), there is a case in which it is difficult to obtain required performance due to small inductance of the coil (7). However, according to this configuration, with the AC-DC converter (1) that does not use the coil (7) of the rotary electric machine (70) and in which appropriate inductance is settable, the AC-DC converter (1) that can perform AC-DC conversion while obtaining sufficient performance such as a power factor correction function can be configured. In addition, the DC-DC converter (2) not requiring high inductance can be configured using the drive system circuit for the rotary electric machine (70), and the cost of the in-vehicle charging device (10) can be reduced. Further, since appropriate inductance is settable in the AC-DC converter (1), it is unnecessary to control the AC-DC converter (1) at a short control period (high control frequency), and it is also easy to reduce loss in a switching element forming the AC-DC converter (1). Therefore, the system efficiency of the in-vehicle charging device (10) is also easily increased. In this manner, according to this configuration, it is possible to configure, while reducing an increase in system cost, the in-vehicle charging device (10) that charges the DC power supply (3) of the vehicle drive device (9) including the rotary electric machine (70), the inverter (5), and the DC power supply (3), with power from the external AC power supply (4), using the coils (7) of the rotary electric machine (70) and the inverter (5).

In the in-vehicle charging device (10), the AC-DC converter (1) preferably includes an inductor (L1) and a full-bridge circuit.

By providing the full-bridge circuit, the AC-DC converter (1) can be caused to function as a bidirectional converter that can perform AC-DC conversion and DC-AC conversion. For example, the in-vehicle charging device (10) can be used as a device having two functions, that is, a function of charging the DC power supply (3) with power supplied from the external AC power supply (4) and a function of supplying AC power to a device outside the vehicle with power stored in the DC power supply (3).

Preferably, the in-vehicle charging device (10) includes a contactor (12) configured to selectively connect a DC-side terminal (T5d) of the inverter (5) and the neutral point (7N) to the DC power supply (3), in which the DC-side terminal (T5d) of the inverter (5) is the first terminal (T21), the neutral point (7N) is the second terminal (T22), and the neutral point (7N) is connected to the DC power supply (3) via the contactor (12).

Simply by changing the connection form with respect to the DC power supply (3) through the contactor (12), it is possible to obtain a circuit in which switching can be made between a function of performing drive control of the rotary electric machine (70) and a function of charging the DC power supply (3) using the external AC power supply 4. That is, the in-vehicle charging device (10) can be configured with a simple configuration.

Preferably, the in-vehicle charging device (10) includes a contactor (11) configured to selectively connect the neutral point (7N) and a DC-side terminal (T1d) of the AC-DC converter (1), in which the neutral point (7N) is the first terminal (T21), the DC-side terminal (T5d) of the inverter (5) is the second terminal (T22), and the neutral point (7N) is connected to the DC-side terminal (T1d) of the AC-DC converter (1) via the contactor (11).

According to this configuration, the DC-DC converter (2) can be used as a step-up converter.

Preferably, the in-vehicle charging device (10) includes: a smoothing capacitor (6) disposed between the AC-DC converter (1) and the DC-DC converter (2), the smoothing capacitor (6) being configured to smooth a voltage of DC power converted by the AC-DC converter (1); and a control device (8) configured to control the AC-DC converter (1) and the DC-DC converter (2), in which the control device (8) is configured to: set a terminal voltage (Vbat) of the DC power supply (3) exhibited when the DC power supply (3) is in a fully charged state, as a first voltage (Vbat_f), and set a voltage that is lower than the first voltage (Vbat_f) and that is preset, as a second voltage (Vbat_s); perform, as charging control, constant power charging control such that charging power (Pbat) based on a current flowing through the DC power supply (3) and a terminal voltage (Vbat) of the DC power supply (3) is constant, until a terminal voltage (Vbat) of the DC power supply (3) reaches the second voltage (Vbat_s) from a state lower than the second voltage (Vbat_s); and perform, in the constant power charging control, variable DC voltage control such that a terminal voltage (Vdc) of the smoothing capacitor (6) increases in accordance with an increase in a terminal voltage (Vbat) of the DC power supply (3).

According to this configuration, the constant power charging control is performed such that the charging power is constant, until the terminal voltage (Vbat) of the DC power supply (3) reaches the second voltage (Vbat_s) from a state in which a state of charge (SOC) of the DC power supply (3) is low and the terminal voltage (Vbat) of the DC power supply (3) is lower than the second voltage (Vbat_s). Therefore, the DC power supply (3) can be charged with the maximum allowable charging power, and thus the charging time can be shortened. In addition, while the constant power charging control is being performed, the variable DC voltage control is also performed. Similarly to the terminal voltage (Vbat) of the DC power supply (3) that increases from lower than the second voltage (Vbat_s) toward the second voltage (Vbat_s) as the constant power charging control is performed, the terminal voltage (Vdc) of the smoothing capacitor (6) is also controlled to increase. Thus, a voltage difference between the input side and the output side of the DC-DC converter (2) is easily kept relatively small, as compared with a case in which the terminal voltage (Vdc) of the smoothing capacitor (6) is kept at a constant voltage higher than the second voltage (Vbat_s). As a result, it is easy to reduce loss such as switching loss in the in-vehicle charging device (10).

Here, in the configuration where the in-vehicle charging device (10) includes the smoothing capacitor (6) and the control device (8), the control device (8) preferably performs, as the charging control, variable power charging control under which the charging power (Pbat) is caused to gradually decrease such that the charging power (Pbat) decreases in accordance with an increase in the terminal voltage (Vbat_s) of the DC power supply (3), after the terminal voltage (Vbat) of the DC power supply (3) has reached the second voltage (Vbat_s) and until the terminal voltage (Vbat) of the DC power supply (3) reaches the first voltage (Vbat_f).

Further, in the configuration where the in-vehicle charging device (10) includes the smoothing capacitor (6) and the control device (8), the control device (8) preferably performs precharging control under which the smoothing capacitor (6) is charged, before performing the charging control.

Further, in a configuration where the control device (8) performs the precharging control, preferably, the in-vehicle charging device (10) includes a contactor (12) configured to selectively connect the DC-side terminal (T5d) of the inverter (5) and the second terminal (T22) of the DC-DC converter (2) to the DC power supply (3), and the control device (8) controls the contactor (12) such that the DC power supply (3) and the DC-side terminal (T5d) of the inverter (5) are connected in the precharging control, and controls the contactor (12) such that the DC power supply (3) and the second terminal (T22) of the DC-DC converter (2) are connected in the charging control.

As one aspect, an in-vehicle charging method is an in-vehicle charging method in which a DC power supply (3) of a vehicle drive device (9) is charged through an in-vehicle charging device (10) to which power is supplied from an external AC power supply (4), the vehicle drive device (9) including: a rotary electric machine (70) including coils (7) of a plurality of phases connected at a neutral point (7N), the rotary electric machine (70) serving as a driving power source for a wheel; an inverter (5) configured to convert power between direct current and alternating current of a plurality of phases; and the DC power supply (3) connected to the inverter (5), where the in-vehicle charging device (10) includes: an AC-DC converter (1) configured to convert AC power from the external AC power supply (4) into DC power; a DC-DC converter (2) configured to convert a voltage of the DC power converted by the AC-DC converter (1); a smoothing capacitor (6) disposed between the AC-DC converter (1) and the DC-DC converter (2), the smoothing capacitor (6) being configured to smooth the voltage of the DC power converted by the AC-DC converter (1); and a control device (8) configured to control the AC-DC converter (1) and the DC-DC converter (2), either one of the AC-DC converter (1) and the DC-DC converter (2) being configured using the inverter (5) and the coils (7) of a plurality of phases, an AC-side terminal (T1a) of the AC-DC converter (1) being connected to the external AC power supply (4), a DC-side terminal (T1d) of the AC-DC converter (1) being connected to a first terminal (T21) of the DC-DC converter (2), a second terminal (T22) of the DC-DC converter (2) being connected to the DC power supply (3), the second terminal (T22) of the DC-DC converter (2) being different from the first terminal (T21) of the DC-DC converter (2), the in-vehicle charging method including: by the control device (8), setting a terminal voltage (Vbat) of the DC power supply (3) exhibited when the DC power supply (3) is in a fully charged state, as a first voltage (Vbat_f), and setting a voltage that is lower than the first voltage (Vbat_f) and that is preset, as a second voltage (Vbat_s), performing, as charging control, constant power charging control such that charging power based on a current flowing through the DC power supply (3) and a terminal voltage (Vbat) of the DC power supply (3) is constant, until a terminal voltage (Vbat) of the DC power supply (3) reaches the second voltage (Vbat_s) from a state lower than the second voltage (Vbat_s), and performing, in the constant power charging control, variable DC voltage control such that a terminal voltage (Vdc) of the smoothing capacitor (6) increases in accordance with an increase in a terminal voltage (Vbat) of the DC power supply (3).

According to this configuration, the constant power charging control is performed such that the charging power (Pbat) is constant, until the terminal voltage (Vbat) of the DC power supply (3) reaches the second voltage (Vbat_s) from a state in which a state of charge (SOC) of the DC power supply (3) is low and the terminal voltage (Vbat) of the DC power supply (3) is lower than the second voltage (Vbat_s). Therefore, the DC power supply (3) can be charged with the maximum allowable charging power, and thus the charging time can be shortened. In addition, while the constant power charging control is being performed, the variable DC voltage control is also performed. Similarly to the terminal voltage (Vbat) of the DC power supply (3) that increases from lower than the second voltage (Vbat_s) toward the second voltage (Vbat_s) as the constant power charging control is performed, the terminal voltage (Vdc) of the smoothing capacitor (6) is also controlled to increase. Thus, a voltage difference between the input side and the output side of the DC-DC converter (2) is easily kept relatively small, as compared with a case in which the terminal voltage (Vdc) of the smoothing capacitor (6) is kept at a constant voltage higher than the second voltage (Vbat_s). As a result, it is easy to reduce loss such as switching loss in the in-vehicle charging device (10). In this manner, according to this configuration, it is possible to provide a technique in which the DC power supply (3) of the vehicle drive device (9) including the rotary electric machine (70), the inverter (5), and the DC power supply (3) can be charged, with high efficiency, through the in-vehicle charging device (10) that performs charging with power from the external AC power supply (4), using the coils (7) of the rotary electric machine (70) and the inverter (5).

Here, in the in-vehicle charging method, it is preferable to, by the control device (8), perform, as the charging control, variable power charging control under which the charging power (Pbat) is caused to gradually decrease such that the charging power (Pbat) decreases in accordance with an increase in a terminal voltage (Vbat) of the DC power supply (3), after a terminal voltage (Vbat) of the DC power supply (3) has reached the second voltage (Vbat_s) and until a terminal voltage (Vbat) of the DC power supply (3) reaches the first voltage (Vbat_f).

If the charging control is continued while keeping the charging power (Pbat) constant, the charging may be performed with the same power even when the terminal voltage (Vbat) of the DC power supply (3) approaches the first voltage (Vbat_f), and the current may be continuously supplied to the DC power supply (3), which may lead to a risk of overcharge. By performing the variable power charging control after the terminal voltage (Vbat) of the DC power supply (3) has reached the second voltage (Vbat_s), such overcharge is easily prevented.

Further, in the in-vehicle charging method, it is preferable to perform, by the control device (8), precharging control under which the smoothing capacitor (6) is charged, before performing the charging control.

Electric charge stored in the smoothing capacitor (6) gradually decreases with discharging, after electrical connection between a supply source of the electric charge and the smoothing capacitor (6) is cut off. When the charging control is started from a state in which the smoothing capacitor (6) is almost completely discharged, the smoothing capacitor (6) is rapidly charged. That is, a large current transiently flows into a path from the supply source of the electric charge to the smoothing capacitor (6) at the start of the charging control. A steady current flowing through the path while the charging control is being performed is much smaller than such a transient current, and thus it is necessary to take measures such as increasing an allowable value of a current allowed to flow through the path in preparation for such a transient current, which may lead to an increase in the device size. When the precharging control for charging the smoothing capacitor (6) is performed before the charging control, it is possible to prevent a large transient current from flowing along with the start of the charging control, and it is easy to simplify the in-vehicle charging device (10) in its configuration.

In the in-vehicle charging method, when the precharging control under which the smoothing capacitor (6) is charged is performed by the control device (8), before the charging control is performed, preferably, the in-vehicle charging device (10) includes a contactor (12) configured to selectively connect a DC-side terminal (T5d) of the inverter (5) and the second terminal (T22) of the DC-DC converter (2) to the DC power supply (3), the precharging control includes controlling, by the control device (8), the contactor (12) such that the DC power supply (3) and the DC-side terminal (T5d) of the inverter (5) are connected, and the charging control includes controlling, by the control device (8), the contactor (12) such that the DC power supply (3) and the second terminal (T22) of the DC-DC converter (2) are connected.

The smoothing capacitor (6) is disposed between the AC-DC converter (1) and the DC-DC converter (2), and is connected between positive and negative terminals of the DC-side terminals (T5d) of the inverter (5). By connecting the DC power supply (3) and the DC-side terminal of the inverter (5) through the contactor (12), electric charge can be directly supplied from the DC power supply (3) to the smoothing capacitor (6) in the precharging control. In the path from the DC power supply (3) to the smoothing capacitor (6), a component (such as a switching element) for which it is necessary to consider the magnitude of a current allowed to flow therethrough is not disposed, and thus the smoothing capacitor (6) can be charged safely and quickly with a simple configuration.

The in-vehicle charging method is preferably performed in a configuration where the in-vehicle charging device (10) includes a contactor (12) configured to selectively connect a DC-side terminal (T5d) of the inverter (5) and the second terminal (T22) of the DC-DC converter (2) to the DC power supply (3), the DC-DC converter (2) is configured with the inverter (5) and the coils (7) of a plurality of phases, the DC-side terminal (T5d) of the inverter (5) is the first terminal (T21), and the neutral point (7N) is the second terminal (T22).

In a case where the in-vehicle charging device (10) is configured in this manner, simply by changing the connection form with respect to the DC power supply (3) through the contactor (12), it is possible to switch between a function of performing drive control of the rotary electric machine (70) and a function of charging the DC power supply (3) using the external AC power supply (4). In addition, it is easy to switch the functions, and thus the in-vehicle charging device (10) can be configured with a simple configuration.

### REFERENCE SIGNS LIST

1: AC-DC converter, 2: DC-DC converter, 3: DC power supply, 4: External AC power supply, 5: Inverter, 6: DC link capacitor (smoothing capacitor), 7: Coil, 7N: Neutral point, 9: Vehicle drive device, 10: In-vehicle charging device, 11: Front-end contactor (contactor), 12: Battery contactor (contactor), 70: Rotary electric machine, L1: Inductor, Pbat: Battery power (charging power), T1a: AC-side terminal (DC-side terminal of AC-DC converter), T1d: DC-side terminal, T21: First terminal, T22: Second terminal, T5d: DC link terminal (DC-side terminal of inverter), Vbat: Battery voltage (terminal voltage of DC power supply), Vbat_f: Fully charged voltage (first voltage), Vbat_s: Switching voltage (second voltage), and Vdc: DC link voltage (terminal voltage of smoothing capacitor)

1. An in-vehicle charging device configured to charge a DC power supply of a vehicle drive device with power supplied from an external AC power supply, the vehicle drive device including: a rotary electric machine including coils of a plurality of phases connected to each other at a neutral point, the rotary electric machine serving as a driving power source for a wheel; an inverter configured to convert power between direct current and alternating current of a plurality of phases; and the DC power supply connected to the inverter, the in-vehicle charging device comprising:
an AC-DC converter configured to convert AC power from the external AC power supply into DC power; and
a DC-DC converter configured with the inverter and the coils of a plurality of phases, one of a DC-side terminal of the inverter and the neutral point of the coils of a plurality of phases being a first terminal of the DC-DC converter and another one of the DC-side terminal of the inverter and the neutral point of the coils of a plurality of phases being a second terminal of the DC-DC converter,
wherein
an AC-side terminal of the AC-DC converter is connected to the external AC power supply,
a DC-side terminal of the AC-DC converter is connected to the first terminal of the DC-DC converter, and
the second terminal of the DC-DC converter is connected to the DC power supply.

2. The in-vehicle charging device according to claim 1, wherein the AC-DC converter includes an inductor and a full-bridge circuit.

3. The in-vehicle charging device according to claim 1, further comprising:
a contactor configured to selectively connect the DC-side terminal of the inverter and the neutral point to the DC power supply,
wherein
the DC-side terminal of the inverter is the first terminal,
the neutral point is the second terminal, and
the neutral point is connected to the DC power supply via the contactor.

4. The in-vehicle charging device according to claim 1, further comprising:
a contactor configured to selectively connect the neutral point and the DC-side terminal of the AC-DC converter,
wherein
the neutral point is the first terminal,
the DC-side terminal of the inverter is the second terminal, and
the neutral point is connected to the DC-side terminal of the AC-DC converter via the contactor.

5. The in-vehicle charging device according to claim 1, further comprising:
a smoothing capacitor disposed between the AC-DC converter and the DC-DC converter, the smoothing capacitor being configured to smooth a voltage of DC power converted by the AC-DC converter; and
a control device configured to control the AC-DC converter and the DC-DC converter,
wherein
the control device is configured to:
set a terminal voltage of the DC power supply exhibited when the DC power supply is in a fully charged state, as a first voltage, and set a voltage that is lower than the first voltage and that is preset, as a second voltage;
perform, as charging control, constant power charging control such that charging power based on a current flowing through the DC power supply and the terminal voltage of the DC power supply is constant, until the terminal voltage of the DC power supply reaches the second voltage from a state lower than the second voltage; and
perform, in the constant power charging control, variable DC voltage control such that a terminal voltage of the smoothing capacitor increases in accordance with an increase in the terminal voltage of the DC power supply.

6. An in-vehicle charging method in which a DC power supply of a vehicle drive device is charged through an in-vehicle charging device to which power is supplied from an external AC power supply, the vehicle drive device including: a rotary electric machine including coils of a plurality of phases connected at a neutral point, the rotary electric machine serving as a driving power source for a wheel; an inverter configured to convert power between direct current and alternating current of a plurality of phases; and the DC power supply connected to the inverter,
wherein
the in-vehicle charging device includes:
an AC-DC converter configured to convert AC power from the external AC power supply into DC power;
a DC-DC converter configured to convert a voltage of the DC power converted by the AC-DC converter;
a smoothing capacitor disposed between the AC-DC converter and the DC-DC converter, the smoothing capacitor being configured to smooth the voltage of the DC power converted by the AC-DC converter; and
a control device configured to control the AC-DC converter and the DC-DC converter,
either one of the AC-DC converter and the DC-DC converter being configured using the inverter and the coils of a plurality of phases,
an AC-side terminal of the AC-DC converter being connected to the external AC power supply,
a DC-side terminal of the AC-DC converter being connected to a first terminal of the DC-DC converter,
a second terminal of the DC-DC converter being connected to the DC power supply, the second terminal of the DC-DC converter being different from the first terminal of the DC-DC converter,
the in-vehicle charging method comprising:
by the control device,
setting a terminal voltage of the DC power supply exhibited when the DC power supply is in a fully charged state, as a first voltage, and setting a voltage that is lower than the first voltage and that is preset, as a second voltage,
performing, as charging control, constant power charging control such that charging power based on a current flowing through the DC power supply and the terminal voltage of the DC power supply is constant, until the terminal voltage of the DC power supply reaches the second voltage from a state lower than the second voltage, and
performing, in the constant power charging control, variable DC voltage control such that a terminal voltage of the smoothing capacitor increases in accordance with an increase in the terminal voltage of the DC power supply.

7. The in-vehicle charging method according to claim 6, further comprising:
by the control device, performing, as the charging control, variable power charging control under which the charging power is caused to gradually decrease such that the charging power decreases in accordance with an increase in the terminal voltage of the DC power supply, after the terminal voltage of the DC power supply has reached the second voltage and until the terminal voltage of the DC power supply reaches the first voltage.

8. The in-vehicle charging method according to claim 6, further comprising:
by the control device, performing precharging control under which the smoothing capacitor is charged, before performing the charging control.

9. The in-vehicle charging method according to claim 8, wherein
the in-vehicle charging device includes a contactor configured to selectively connect a DC-side terminal of the inverter and the second terminal of the DC-DC converter to the DC power supply,
the precharging control includes controlling, by the control device, the contactor such that the DC power supply and the DC-side terminal of the inverter are connected, and
the charging control includes controlling, by the control device, the contactor such that the DC power supply and the second terminal of the DC-DC converter are connected.

10. The in-vehicle charging method according to claim 6, wherein
the in-vehicle charging device includes a contactor configured to selectively connect a DC-side terminal of the inverter and the second terminal of the DC-DC converter to the DC power supply,
the DC-DC converter is configured with the inverter and the coils of a plurality of phases,
the DC-side terminal of the inverter is the first terminal, and
the neutral point is the second terminal.
